(19) United States
(12) Patent Application Publication
(10) Pub. No.: US 2026/0080233 A1
(43) Pub. Date: Mar. 19, 2026

(54) NEURAL NETWORK DEVICE AND SIGNAL PROCESSING METHOD

(71) Applicant: KABUSHIKI KAISHA TOSHIBA, Tokyo (JP)

(72) Inventors: Kazuki MINEGISHI, Yokohama Kanagawa (JP); Masato Oda, Yokohama Kanagawa (JP); Kumiko Nomura, Shinagawa Tokyo (JP); Yoshifumi Nishi, Yokohama Kanagawa (JP)

(73) Assignee: KABUSHIKI KAISHA TOSHIBA, Tokyo (JP)

(21) Appl. No.: 19/286,905

(22) Filed: Jul. 31, 2025

(30) Foreign Application Priority Data
Sep. 18, 2024 (JP) 2024-161048

(51) Int. Cl. G06N 3/063; G06N 3/049

(52) U.S. Cl. CPC G06N 3/063; G06N 3/049

(57) ABSTRACT

A neural network device according to an embodiment includes a plurality of synapse circuits and a plurality of neuron circuits. A first neuron circuit out of the neuron circuits includes an input circuit, a charge holding circuit, a comparison circuit, a firing circuit, a charge control circuit, and a control signal output circuit. When a determination signal changes from a second value to a first value, the firing circuit outputs a spike signal. The control signal output circuit outputs a control signal indicating a comparison voltage that is based on an excess component of a membrane potential exceeding a threshold potential. In response to acquiring the spike signal from the first neuron circuit, a first synapse circuit out of the synapse circuits that acquires the spike signal from the first neuron circuit outputs a synaptic current of a current amount corresponding to the control signal and a synaptic weight.

### CROSS-REFERENCE TO RELATED APPLICATIONS

This application is based upon and claims the benefit of priority from Japanese Patent Application No. 2024-161048, filed on Sep. 18, 2024; the entire contents of which are incorporated herein by reference.

### FIELD

Embodiments of the present invention relate to a neural network device and a signal processing method.

### BACKGROUND

A spiking neural network (SNN) is a neural network that performs information processing using a spike signal. A neural network circuit that implements a spiking neural network includes a plurality of neuron circuits and a plurality of synapse circuits. Each of the synapse circuits couples two of the neuron circuits.

Each of the neuron circuits holds, with a charge holding unit such as a capacitor, charge due to a synaptic current supplied from the synapse circuit of the preceding stage. In addition, each of the neuron circuits includes a comparator that compares the held charge amount with a threshold, and generates a spike signal when the held charge amount is larger than the threshold. In addition, each of the neuron circuits discharges the charge held in the charge holding unit in response to the generation of the spike signal, and resets the charge amount held by the charge holding unit. In addition, each of the synapse circuits acquires the spike signal from the neuron circuit of the preceding stage, and outputs a synaptic current obtained by multiplying the spike signal by a synaptic weight by a variable resistance element or the like.

In recent years, a technique for substituting a spiking neural network for a task such as image processing executed using arithmetic operation artificial intelligence (AI) such as convolutional neural network (CNN) has been publicly known. However, the spiking neural network executes discrete information processing. For this reason, when a task such as image processing is executed by the spiking neural network, there is a problem that information missing occurs.

The cause of this information missing is that when the charge amount held in the neuron circuit of the preceding stage exceeds the threshold, the excess charge amount of the held charge amount exceeding the threshold is not transmitted to the neuron circuit of the subsequent stage. In order to solve such a problem, for example, a spiking neural network that adjusts the reset discharge amount of the held charge using the magnitude of the excess charge amount is known. In this spiking neural network, the occurrence frequency of the spike signal is increased by the excess charge amount, thereby reducing the information missing. However, since the spiking neural network applies the effect of the excess charge amount to the processing after generating the spike signal, a time delay occurs in reflecting the excess charge amount.

For the reasons above, when attempting to accurately implementing a task such as image processing by the spiking neural network, it is necessary to reduce information missing and information transmission delay.

### BRIEF DESCRIPTION OF THE DRAWINGS

FIG. 1 is a diagram illustrating an example of a configuration of a neural network device;

FIG. 2 is a connection relationship diagram of a peripheral circuit of a first neuron circuit according to a first embodiment;

FIG. 3 is a diagram illustrating a configuration of the first neuron circuit according to the first embodiment;

FIG. 4 is a diagram illustrating a first example of a configuration of a control signal output circuit;

FIG. 5 is a diagram illustrating a second example of a configuration of a control signal output circuit;

FIG. 6 is a diagram illustrating a first example of a configuration of a first synapse circuit;

FIG. 7 is a diagram illustrating a second example of a configuration of a first synapse circuit;

FIG. 8 is a diagram illustrating an example of waveforms of a membrane potential and a synaptic current according to the first embodiment;

FIG. 9 is a connection relationship diagram of a peripheral circuit of a first neuron circuit according to a second embodiment;

FIG. 10 is a diagram illustrating a configuration of the first neuron circuit according to the second embodiment;

FIG. 11 is a diagram illustrating an example of waveforms of a membrane potential and a synaptic current according to the second embodiment;

FIG. 12 is a connection relationship diagram of a peripheral circuit of a first neuron circuit according to a third embodiment;

FIG. 13 is a diagram illustrating a configuration of the first neuron circuit according to the third embodiment;

FIG. 14 is a diagram illustrating an example of waveforms of a membrane potential and a synaptic current according to the third embodiment;

FIG. 15 is a diagram illustrating a configuration of a first neuron circuit according to a first modification;

FIG. 16 is a diagram illustrating a configuration of a first neuron circuit according to a second modification;

FIG. 17 is a diagram illustrating a configuration of a first neuron circuit according to a third modification;

FIG. 18 is a diagram illustrating a configuration of a first neuron circuit according to a fourth modification;

FIG. 19 is a diagram illustrating a configuration of a first neuron circuit according to a fifth modification;

FIG. 20 is a diagram illustrating a configuration of a first neuron circuit according to a sixth modification;

FIG. 21 is a diagram illustrating a configuration of a first neuron circuit according to a seventh modification;

FIG. 22 is a diagram illustrating a configuration of a first neuron circuit according to an eighth modification;

FIG. 23 is a diagram illustrating a configuration of a first neuron circuit according to a ninth modification;

FIG. 24 is a diagram illustrating a configuration of a first neuron circuit according to a tenth modification;

FIG. 25 is a diagram illustrating a neural network device of a first hierarchical configuration example;

FIG. 26 is a diagram illustrating a neural network device of a second hierarchical configuration example;

FIG. 27 is a diagram illustrating a neural network device of a third hierarchical configuration example;

FIG. 28 is a diagram illustrating a neural network device of a fourth hierarchical configuration example;

FIG. 29 is a diagram illustrating a neural network device of a fifth hierarchical configuration example;

FIG. 30 is a connection relationship diagram around a first neuron circuit of a sixth hierarchical configuration example;

FIG. 31 is a connection relationship diagram around a first neuron circuit of a seventh hierarchical configuration example;

FIG. 32 is a connection relationship diagram around a first neuron circuit of an eighth hierarchical configuration example; and

FIG. 33 is a connection relationship diagram around a first neuron circuit of a ninth hierarchical configuration example.

### DETAILED DESCRIPTION

A neural network device according to one embodiment includes a plurality of synapse circuits and a plurality of neuron circuits. Each of the synapse circuits is given a synaptic weight. Each of the neuron circuits outputs a spike signal being a voltage pulse. Each of the synapse circuits acquires the spike signal output from one of the neuron circuits. In response to acquiring the spike signal, each of the synapse circuits outputs a synaptic current of a current amount corresponding to the synaptic weight given to the corresponding synapse circuit. A first neuron circuit out of the neuron circuits includes an input circuit, a charge holding circuit, a comparison circuit, a firing circuit, a charge control circuit, and a control signal output circuit. The input circuit is configured to acquire the synaptic current from one or more of the synapse circuits. The charge holding circuit is configured to accumulate charge corresponding to the synaptic current acquired by the input circuit and generate a membrane potential corresponding to the accumulated charge. The comparison circuit is configured to generate a determination signal with a first value or a second value. The first value is applied when a sign of a difference voltage between a preset threshold potential and the membrane potential is a first sign. The second value is applied when the sign of the difference voltage is a second sign different from the first sign. The firing circuit is configured to output the spike signal when the determination signal changes from the second value to the first value. The charge control circuit is configured to, after the spike signal is output, charge or discharge the charge accumulated in the charge holding circuit to cause the sign of the differential voltage to become the second sign. The control signal output circuit is configured to output a control signal representing a comparison voltage being based on an excess component of the membrane potential exceeding the threshold potential. Each of one or more of first synapse circuits, by which the spike signal is acquired from the first neuron circuit, outputs the synaptic current with a current amount corresponding to the control signal and the synaptic weight in response to acquiring the spike signal from the first neuron circuit.

Hereinafter, a neural network device 10 according to an embodiment will be described with reference to the drawings.

### First Embodiment

The neural network device 10 according to the first embodiment is a spiking-type neural network configured by hardware. For example, the neural network device 10 is mounted on a semiconductor device by a process such as a complementary metal oxide semiconductor (CMOS).

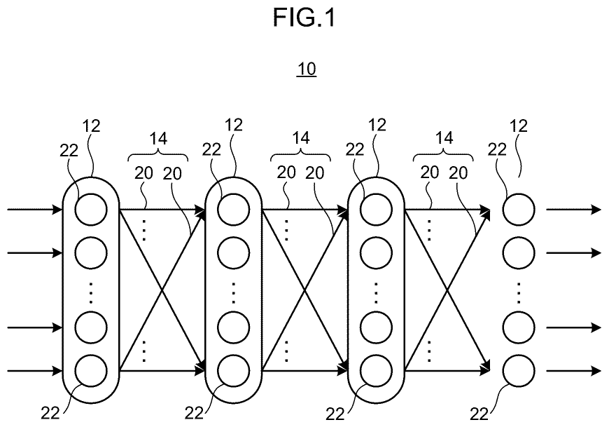

FIG. 1 is a diagram illustrating an example of a configuration of the neural network device 10. As an example, the neural network device 10 according to the first embodiment includes M (M is an integer of 2 or more) layers 12 and (M−1) synapse groups 14.

Each of the (M−1) synapse groups 14 includes a plurality of synapse circuits 20. A synaptic weight is given to each of the synapse circuits 20. The synaptic weights for the synapse circuits 20 are set by learning processing, random numbers, or the like. The synaptic weights for the synapse circuits 20 may be updated by a predetermined update rule such as Spike Timing Dependent Plasticity (STDP) or Spike Driven Synaptic Plasticity (SDSP).

Each of the M layers 12 includes a plurality of neuron circuits 22. Each of the neuron circuits 22 outputs a spike signal. The spike signal is a voltage pulse that changes from a second voltage to a first voltage, and returns to the second voltage after a lapse of a certain time from the change from the second voltage to the first voltage.

An m-th (m is an integer of 1 or more and (M−1) or less) synapse group 14 among the (M−1) synapse groups 14 is disposed between an m-th layer 12 of the M layers 12 and an (m+1)-th layer 12 of the M layers 12.

Each of the synapse circuits 20 included in the m-th synapse group 14 acquires a spike signal output from any one neuron circuit 22 among the neuron circuits 22 included in the m-th layer 12. When the spike signal is acquired, each of the synapse circuits 20 included in the m-th synapse group 14 outputs a synaptic current of the current amount corresponding to the preset synaptic weight and the acquired spike signal. Note that the synaptic weight may be represented by a binary value or may be represented by a multivalued discrete value of three or more values. In addition, the synaptic weight may be represented by an analog value by an amount of charge accumulated in a capacitor or the like or a resistance value of a variable resistor.

Then, each of the synapse circuits 20 included in the m-th synapse group 14 applies a synaptic current to one neuron circuit 22 among the neuron circuits 22 included in the (m+1)-th layer 12.

Each of the neuron circuits 22 included in the (m+1)-th layer 12 among the M layers 12 acquires synaptic currents output from the m-th synapse group 14, and executes processing corresponding to a product-sum operation on the acquired synaptic currents. Note that the first layer 12 of the M layers 12 acquires signals from an external device or an input layer. Then, each of the neuron circuits 22 outputs a spike signal obtained by performing processing corresponding to an activation function on the signal representing the operation result.

In such a neural network device 10, the first layer 12 receives one or more signals from an external device or an input layer. Then, the neural network device 10 outputs, from the M-th layer 12, one or more signals indicating a result of the operation executed by the neural network on the one or more signals received.

Such a neural network device 10 executes arithmetic neural network operation such as CNN. As a result, the neural network device 10 can execute tasks such as image recognition and classification processing with less energy consumption and a small-scale circuit without using a CPU and a GPU.

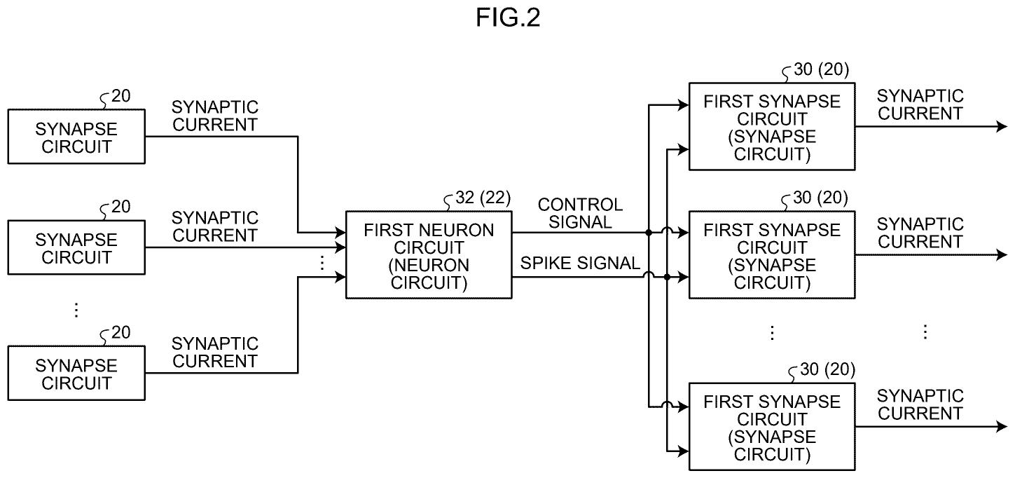

FIG. 2 is a diagram illustrating a connection relationship of a peripheral circuit of a first neuron circuit 32 according to the first embodiment.

Each of the neuron circuits 22 holds an inner potential called a membrane potential Vₘₑₘ. When having acquired a synaptic current from any of the synapse circuits 20 connected as the preceding stage, the neuron circuit 22 increases the membrane potential Vₘₑₘ in accordance with the magnitude of the acquired synaptic current. As a result, each of the neuron circuits 22 can execute processing corresponding to the product-sum operation on the synaptic currents acquired.

When not having acquired the synaptic current, each of the neuron circuits 22 may lower the membrane potential Vₘₑₘ with the lapse of time. In this case, each of the neuron circuits 22 increases the membrane potential Vₘₑₘ when having continuously acquired the synaptic current repeatedly at short time intervals, and lowers the membrane potential Vₘₑₘ when not having acquired the synaptic current for a long period of time. Note that, when the membrane potential Vₘₑₘ reaches a predetermined initial potential by lowering the membrane potential Vₘₑₘ with the lapse of time, each of the neuron circuits 22 stops lowering of the membrane potential Vₘₑₘ.

Then, when the membrane potential Vₘₑₘ has increased to reach a predetermined threshold potential Vₜₕ or more, each of the neuron circuits 22 fires and outputs a spike signal to the synapse circuit 20 of the subsequent stage. When having fired, each of the neuron circuits 22 returns the membrane potential Vₘₑₘ to the initial potential.

In addition, during a refractory period being a predetermined time after firing, each of the neuron circuits 22 does not increase the membrane potential Vₘₑₘ and stops further firing even when a synaptic current is applied. In this case, after the end of the refractory period, each of the neuron circuits 22 starts accumulation of charges corresponding to the synaptic current. Note that the initial potential is smaller than the threshold potential Vₜₕ.

Each of the synapse circuits 20 acquires a spike signal output from any one neuron circuit 22 among the neuron circuits 22.

Each of the synapse circuits 20 has a circuit that generates a current. When the spike signal is acquired, each of the synapse circuits 20 outputs a synaptic current of the current amount corresponding to the preset synaptic weight and the acquired spike signal to the neuron circuit 22 of the subsequent stage by using the circuit that generates current.

Here, the first neuron circuit 32 of the neuron circuits 22 outputs a control signal together with a spike signal.

The control signal represents a comparison voltage based on the excess component when the membrane potential Vₘₑₘ exceeds the threshold potential Vₜₕ. The excess component is a component of the membrane potential Vₘₑₘ exceeding the threshold potential Vₜₕ. For example, the comparison voltage is the membrane potential Vₘₑₘ. In addition, for example, the comparison voltage may be a difference voltage obtained by subtracting the threshold potential Vₜₕ from the membrane potential Vₘₑₘ. Such a control signal can represent an excess component of the membrane potential Vₘₑₘ exceeding the threshold potential Vₜₕ when the spike signal is fired.

Note that the control signal may be an analog voltage or digital data.

In addition, each of one or more first synapse circuits 30, which acquires the spike signal from the first neuron circuit 32 among the synapse circuits 20, acquires the control signal together with the spike signal from the first neuron circuit 32.

When the spike signal is acquired from the first neuron circuit 32, each of the one or more first synapse circuits 30 outputs a synaptic current of the current amount corresponding to the acquired control signal and the synaptic weight. For example, each of the one or more first synapse circuits 30 increases the amplitude of the output synaptic current as the comparison voltage represented by the control signal is larger. As a result, each of the one or more first synapse circuits 30 can increase the current amount of the synaptic current as the excess component at the time of firing of the first neuron circuit 32 is larger when the synaptic weight is a fixed value.

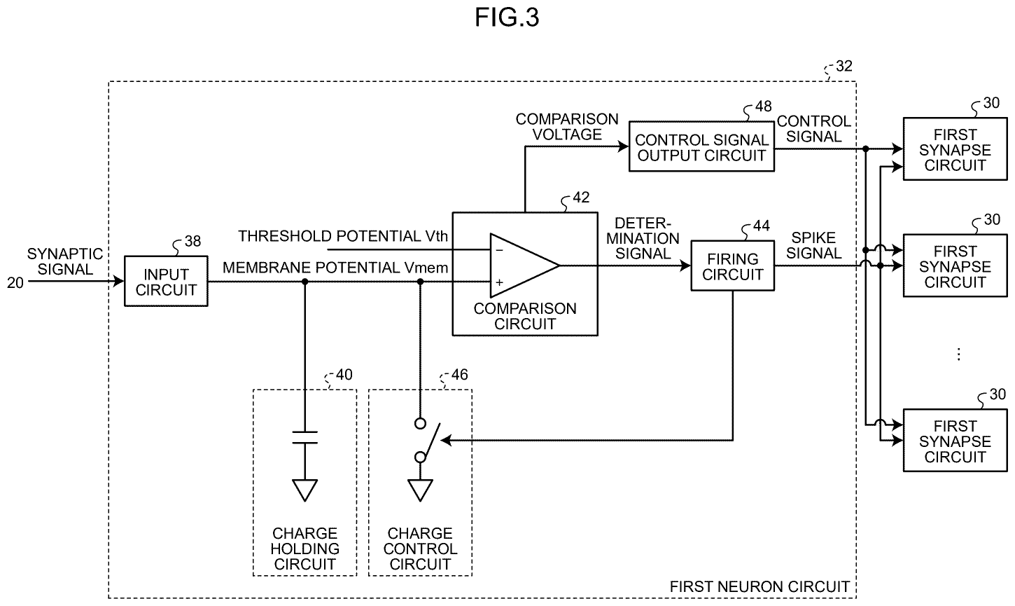

FIG. 3 is a diagram illustrating a configuration of the first neuron circuit 32 according to the first embodiment together with the first synapse circuits 30 connected to the first neuron circuit 32.

Note that, in the neural network device 10, all the neuron circuits 22 may have the same configuration as the first neuron circuit 32, or some of the neuron circuits 22 may have the same configuration as the first neuron circuit 32.

In the first neuron circuit 32, each of one or the synapse circuits 20 among the synapse circuits 20 is connected as the preceding stage. The first neuron circuit 32 is supplied with a synaptic current from each of one or the synapse circuits 20 connected as the preceding stage of the first neuron circuit 32.

In addition, in the first neuron circuit 32, one or more first synapse circuits 30 are connected as the subsequent stage. The first neuron circuit 32 outputs a spike signal and a control signal to each of the one or more first synapse circuits 30.

The first neuron circuit 32 includes an input circuit 38, a charge holding circuit 40, a comparison circuit 42, a firing circuit 44, a charge control circuit 46, and a control signal output circuit 48.

The input circuit 38 acquires a synaptic current from each of one or more synapse circuits 20 connected to the first neuron circuit 32 among the synapse circuits 20. The input circuit 38 may be a simple electric wire, an electrode terminal, or the like.

The charge holding circuit 40 accumulates charges corresponding to the current amount of the synaptic current acquired by the input circuit 38. The charge holding circuit 40 generates a membrane potential Vₘₑₘ corresponding to the accumulated charges. Accordingly, every time the synaptic current is supplied, the charge holding circuit 40 increases the membrane potential Vₘₑₘ in accordance with the current amount of the supplied synaptic current. For example, the charge holding circuit 40 is a capacitor having one terminal connected to a ground terminal and having the other terminal generating the membrane potential Vₘₑₘ.

The comparison circuit 42 acquires the membrane potential Vₘₑₘ generated from the charge holding circuit 40. In addition, the comparison circuit 42 acquires a preset threshold potential Vₜₕ. The comparison circuit 42 generates a determination signal that has a first value in a case where the membrane potential Vₘₑₘ is larger than the threshold potential Vₜₕ, and has a second value in a case where the membrane potential Vₘₑₘ is not larger than the threshold potential Vₜₕ.

For example, the comparison circuit 42 is a comparator mounted on a semiconductor device. In the comparator, the threshold potential Vₜₕ is applied to an inverting input terminal, and the membrane potential Vₘₑₘ is applied to a non-inverting input terminal. Then, the comparator outputs a determination signal indicating whether the membrane potential Vₘₑₘ is larger than the threshold potential Vₜₕ. For example, the comparator outputs a determination signal that has a first value (for example, logical H) when determining that the membrane potential Vₘₑₘ is larger than the threshold potential Vₜₕ, and has a second value (for example, logical L) when determining that the membrane potential Vₘₑₘ is not larger than the threshold potential Vₜₕ.

The firing circuit 44 acquires the determination signal from the comparison circuit 42. When the determination signal changes from the second value to the first value, the firing circuit 44 outputs a spike signal that is a voltage pulse having a predetermined time width. That is, when the state in which the membrane potential Vₘₑₘ is not larger than the threshold potential Vₜₕ is changed to the state in which the membrane potential Vₘₑₘ is larger than the threshold potential Vₜₕ, the firing circuit 44 outputs a spike signal that is a voltage pulse. For example, when the state in which the membrane potential Vₘₑₘ is not larger than the threshold potential Vₜₕ is changed to the state in which the membrane potential Vₘₑₘ is larger than the threshold potential Vₜₕ, the firing circuit 44 outputs a spike signal that changes from a second voltage to a first voltage and returns to the second voltage after a lapse of a certain time from the change from the second voltage to the first voltage.

The charge control circuit 46 releases the charges accumulated in the charge holding circuit 40 after the firing circuit 44 outputs the spike signal. For example, the charge control circuit 46 releases the charges accumulated in the charge holding circuit 40 in a predetermined period after the firing circuit 44 outputs the spike signal.

For example, the charge control circuit 46 releases the charges accumulated in the charge holding circuit 40 by connecting the terminal of the charge holding circuit 40 that generates the membrane potential Vₘₑₘ to the ground terminal. For example, the charge control circuit 46 is a switch that turns on or off between the terminal of the charge holding circuit 40 that generates the membrane potential Vₘₑₘ and the ground terminal. For example, the switch is implemented by a metal-oxide-semiconductor field-effect transistor (MOSFET) or the like mounted on a semiconductor device.

Such a charge control circuit 46 can release the charges accumulated in the charge holding circuit 40 to the ground terminal and return the membrane potential Vₘₑₘ generated from the charge holding circuit 40 to the initial potential. In addition, the charge control circuit 46 can cause a synaptic current supplied from the synapse circuit 20 of the preceding stage to flow to the ground terminal such that charges are not accumulated in the charge holding circuit 40. Further, the charge control circuit 46 can apply the potential of the ground terminal to the comparison circuit 42 instead of the membrane potential Vₘₑₘ generated from the charge holding circuit 40 such that a spike signal is not generated. Then, the charge control circuit 46 can stop the release of the charges from the charge holding circuit 40 after a predetermined period has elapsed from the start of the release of the charge, and can accumulate charges corresponding to the synaptic current acquired by the input circuit 38 in the charge holding circuit 40.

The control signal output circuit 48 acquires the comparison voltage. Then, the control signal output circuit 48 outputs a control signal indicating the acquired comparison voltage. The comparison voltage is a voltage based on the excess component of the membrane potential Vₘₑₘ exceeding the threshold potential Vₜₕ.

The control signal output circuit 48 may output an analog voltage representing the comparison voltage as a control signal. In addition, the control signal output circuit 48 may output digital data representing the comparison voltage as a control signal.

The first neuron circuit 32 having such a configuration can output a spike signal indicating a timing at which the membrane potential Vₘₑₘ becomes larger than the threshold potential Vₜₕ, and a control signal indicating the excess component of the membrane potential Vₘₑₘ exceeding the threshold potential Vₜₕ.

Note that the first neuron circuit 32 illustrated in FIG. 3 has a configuration in a case where the threshold potential Vₜₕ is larger than a predetermined reference potential such as a ground potential. However, the first neuron circuit 32 may have a configuration in which the threshold potential Vₜₕ is inverted in positive and negative and smaller than a reference potential such as a ground potential.

In the case of the configuration in which the positive and negative are inverted, every time the synaptic current is supplied, the charge holding circuit 40 lowers the membrane potential Vₘₑₘ in accordance with the current amount of the supplied synaptic current. In addition, the comparison circuit 42 generates a determination signal that has a first value in a case where the membrane potential Vₘₑₘ is smaller than the threshold potential Vₜₕ, and has a second value in a case where the membrane potential Vₘₑₘ is not smaller than the threshold potential Vₜₕ. In addition, the charge control circuit 46 causes the charge holding circuit 40 to be charged with charges after the firing circuit 44 outputs the spike signal.

Accordingly, even in the configuration in which the positive and negative are not inverted or in the configuration in which the positive and negative are inverted, the comparison circuit 42 generates the determination signal that has the first value when the sign of the difference voltage between the threshold potential Vₜₕ and the membrane potential Vₘₑₘ is a first sign and has the second value when the sign of the difference voltage is a second sign different from the first sign. In addition, after the spike signal is output, the charge control circuit 46 charges or discharges the charges accumulated in the charge holding circuit 40 such that the sign of the difference voltage becomes the second sign. Note that the same applies to the second and subsequent embodiments.

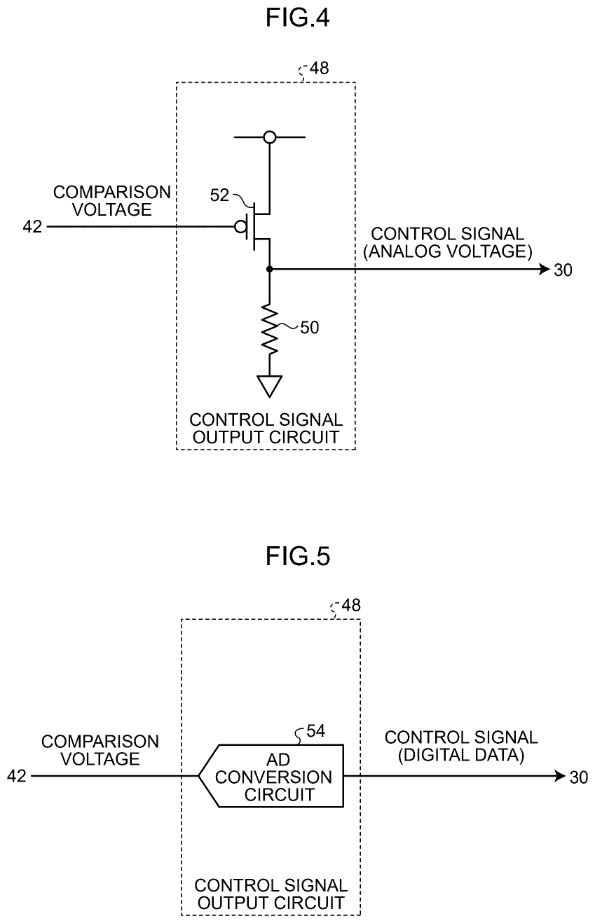

FIG. 4 is a diagram illustrating a first example of a configuration of the control signal output circuit 48. For example, as illustrated in FIG. 4, the control signal output circuit 48 may include a first resistor 50 and a voltage control MOSFET 52. One terminal of the first resistor 50 is connected to a ground terminal.

The voltage control MOSFET 52 is, for example, a p-type MOSFET. The voltage control MOSFET 52 has the drain connected to a power supply voltage terminal and the source connected to a terminal on a side of the first resistor 50 to which the ground terminal is not connected. Then, the comparison voltage is applied to the gate of the voltage control MOSFET 52. The voltage control MOSFET 52 changes the current amount flowing between the drain and the source in accordance with the comparison voltage. Accordingly, the voltage control MOSFET 52 can change the voltage generated in the first resistor 50 in accordance with the comparison voltage.

The control signal output circuit 48 having such a configuration outputs, as a control signal, a voltage generated from the terminal on the side of the first resistor 50 to which the ground terminal is not connected. As a result, the control signal output circuit 48 can output a control signal represented by an analog voltage.

FIG. 5 is a diagram illustrating a second example of a configuration of the control signal output circuit 48. As illustrated in FIG. 5, the control signal output circuit 48 may include an AD conversion circuit 54.

The AD conversion circuit 54 acquires the comparison voltage, and analog-digital converts the comparison voltage to generate digital data representing the comparison voltage. For example, the AD conversion circuit 54 is an integral-type AD converter that alternately repeats a sample period and a hold period in a predetermined cycle. In this case, the AD conversion circuit 54 accumulates the comparison voltage in a sampling capacitor in the sample period. Subsequently, in the hold period, the AD conversion circuit 54 releases the charges accumulated in the sampling capacitor, and measures the time when the voltage of the sampling capacitor decreases to a predetermined voltage using a counter. Then, the AD conversion circuit 54 outputs digital data representing the count value of the counter as a control signal.

As a result, the control signal output circuit 48 can output a control signal represented by the digital data. Note that the AD conversion circuit 54 is not limited to an integral type, and may be an AD converter of another system.

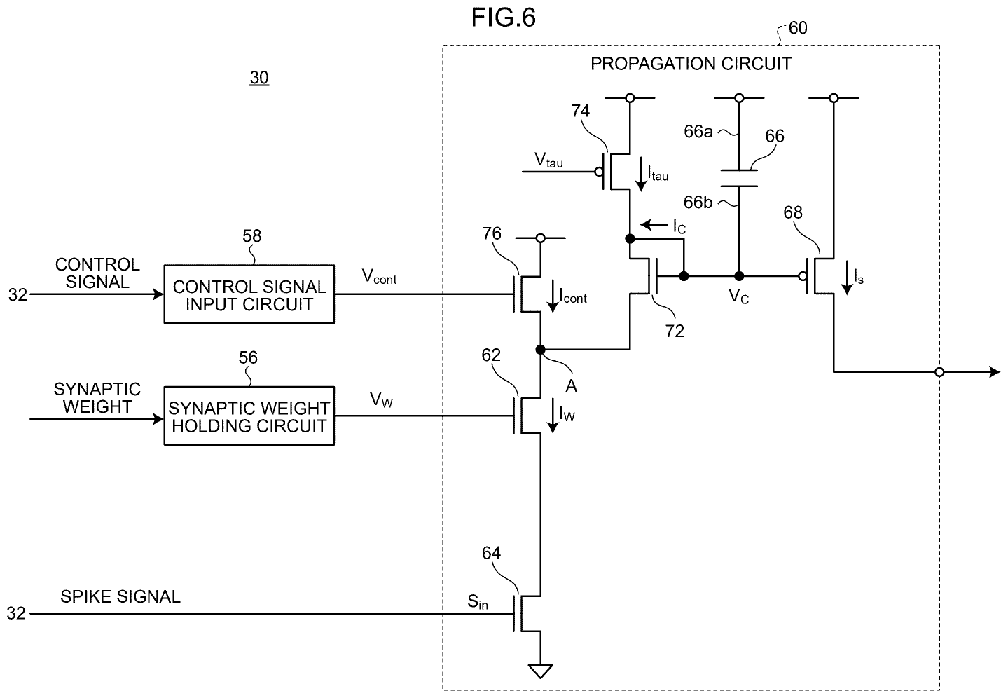

FIG. 6 is a diagram illustrating a first example of a configuration of the first synapse circuit 30. For example, the first synapse circuit 30 may have a configuration as illustrated in FIG. 6. For example, the first synapse circuit 30 includes a synaptic weight holding circuit 56, a control signal input circuit 58, and a propagation circuit 60.

The synaptic weight holding circuit 56 holds a preset synaptic weight (W). The synaptic weight holding circuit 56 may include, for example, a variable resistor whose resistance value changes with the synaptic weight (W). The synaptic weight holding circuit 56 may include, for example, a holding capacitor that accumulates charges corresponding to the synaptic weight (W). In addition, the synaptic weight holding circuit 56 may include a memory or the like and store a digital value corresponding to the synaptic weight (W). In the present embodiment, the synaptic weight holding circuit 56 generates a weight voltage (V_{W}) corresponding to the preset synaptic weight (W).

The control signal input circuit 58 acquires a control signal from the first neuron circuit 32. The control signal input circuit 58 outputs a control voltage (V_{cont}) corresponding to the control signal. In a case where the control signal is an analog voltage, the control signal input circuit 58 may output the control signal as the control voltage (V_{cont}) by buffering or amplifying the control signal, or may output the control signal as it is as the control voltage (V_{cont}). When the control signal is digital data, the control signal input circuit 58 converts the control signal into an analog voltage and outputs the converted analog voltage as the control voltage (V_{cont}).

The propagation circuit 60 receives a spike signal (Sᵢₙ) from the first neuron circuit 32. In addition, the propagation circuit 60 receives the weight voltage (V_{W}) from the synaptic weight holding circuit 56. In addition, the propagation circuit 60 receives the control voltage (V_{cont}) from the control signal input circuit 58.

The propagation circuit 60 outputs a synaptic current (Iₛ) of the current amount corresponding to the spike signal (Sᵢₙ), the synaptic weight (W), and the control voltage (V_{cont}). For example, in a case where the control voltage (V_{cont}) is a predetermined value larger than zero and the spike signal (Sᵢₙ) is the first voltage, the propagation circuit 60 outputs the synaptic current (Iₛ) of a larger current amount as the control voltage (V_{cont}) is larger. In addition, for example, in a case where the control voltage (V_{cont}) is a predetermined value and the spike signal (Sᵢₙ) is the first voltage, the propagation circuit 60 outputs the synaptic current (Iₛ) of a larger current amount as the synaptic weight (W) is larger. In addition, when the spike signal (Sᵢₙ) is the second voltage, the propagation circuit 60 does not output the synaptic current (Iₛ) regardless of the synaptic weight (W) and the control voltage (V_{cont}).

For example, the propagation circuit 60 includes a weight current circuit 62, a spike input circuit 64, a first capacitor 66, an output amplifier circuit 68, a charge adjustment circuit 72, a current supply circuit 74, and a current control circuit 76.

When the spike signal (Sᵢₙ) is the first voltage, the weight current circuit 62 causes a weight current (I_{W}) of a current value corresponding to the synaptic weight (W) set in the synaptic weight holding circuit 56 to flow. For example, the weight current circuit 62 causes a weight current (I_{W}) proportional to the synaptic weight (W) to flow.

The weight current circuit 62 is, for example, a MOSFET. In the example of FIG. 6, the weight current circuit 62 is an N-channel MOSFET. The weight current circuit 62 that is a MOSFET has the gate to which a weight voltage (V_{W}) is applied and the drain connected to a node A. Then, the weight current circuit 62 that is a MOSFET causes the weight current (I_{W}) of a current amount corresponding to the weight voltage (V_{W}) to flow between the drain and the source.

The spike input circuit 64 receives the spike signal (Sᵢₙ) output from the first neuron circuit 32. The spike input circuit 64 switches whether or not to cause the weight current circuit 62 to flow the weight current (I_{W}) in accordance with the spike signal (Sᵢₙ) output from the first neuron circuit 32. For example, the spike input circuit 64 causes the weight current (I_{W}) to flow when the spike signal (Sᵢₙ) is the first voltage. For example, the spike input circuit 64 does not cause the weight current (I_{W}) to flow when the spike signal (Sᵢₙ) is the second voltage. That is, the spike input circuit 64 sets the weight current (I_{W}) to zero when the spike signal (Sᵢₙ) is the second voltage.

In the present embodiment, the spike input circuit 64 is a MOSFET that performs a switching operation. In the example of FIG. 6, the spike input circuit 64 is an N-channel MOSFET. The spike input circuit 64 that is a MOSFET has the gate to which the spike signal (Sᵢₙ) is applied, the drain connected to the source of the weight current circuit 62, and the source connected to a reference potential (ground).

Then, the spike input circuit 64 that is a MOSFET is in an ON state when the spike signal (Sᵢₙ) is the first voltage, and causes the weight current circuit 62 to flow the weight current (I_{W}) by connecting the source of the weight current circuit 62 to the ground. In addition, the spike input circuit 64 that is a MOSFET is in an OFF state when the spike signal (Sᵢₙ) is the second voltage, and does not cause the weight current circuit 62 to flow the weight current (I_{W}) by disconnecting the source of the weight current circuit 62 from the ground.

The first capacitor 66 has a first terminal 66a and a second terminal 66b. The first terminal 66a of the first capacitor 66 is connected to a power supply voltage at which a constant voltage is generated. In such a first capacitor 66, a constant voltage is applied to the first terminal 66a. In addition, the first capacitor 66 generates a capacitor voltage (V_{C}) at the second terminal 66b. The capacitor voltage (V_{C}) is a value obtained by subtracting the voltage generated by the first capacitor 66 from the power supply potential. The voltage generated by the first capacitor 66 is a voltage obtained by dividing the amount of accumulated charge by the capacitance.

The output amplifier circuit 68 outputs a synaptic current (Iₛ) corresponding to the capacitor voltage (V_{C}) generated at the second terminal 66b of the first capacitor 66. For example, the output amplifier circuit 68 is a MOSFET. In the example of FIG. 6, the output amplifier circuit 68 is a P-channel MOSFET. The output amplifier circuit 68 that is a P-channel MOSFET has the gate to which the capacitor voltage (V_{C}) is applied, the source connected to the power supply potential, and the drain connected to an output terminal of the synaptic current. Then, the output amplifier circuit 68 that is a MOSFET causes the synaptic current (Iₛ) corresponding to the capacitor voltage (V_{C}) to flow between the drain and the source.

When the weight current (I_{W}) flows by the spike input circuit 64, the charge adjustment circuit 72 reduces or increases the charge accumulated in the first capacitor 66 by a temporal change amount corresponding to the current value of the weight current (I_{W}). For example, the charge adjustment circuit 72 reduces or increases the charge accumulated in the first capacitor 66 when the spike input circuit 64 is in the ON state.

In addition, the charge adjustment circuit 72 makes the charge accumulated in the first capacitor 66 constant when the weight current (I_{W}) does not flow by the spike input circuit 64. For example, the charge adjustment circuit 72 does not change the charge accumulated in the first capacitor 66 when the spike input circuit 64 is in the OFF state.

For example, the charge adjustment circuit 72 is a diode-connected MOSFET. In the example of FIG. 6, the charge adjustment circuit 72 is a diode-connected N-channel MOSFET. The charge adjustment circuit 72 that is an N-channel MOSFET has the gate and the drain connected, the gate to which the second terminal 66b of the first capacitor 66 is connected, and the source connected to the node A. Then, when the weight current (I_{W}) flows through the node A, the charge adjustment circuit 72 that is a MOSFET draws a capacitor current (I_{C}) from the second terminal 66b of the first capacitor 66 and supplies the capacitor current (I_{C}) to the node A. Alternatively, the charge adjustment circuit 72 that is a MOSFET draws the capacitor current (I_{C}) from the node A and supplies the capacitor current (I_{C}) to the second terminal 66b of the first capacitor 66.

As a result, the charge adjustment circuit 72 can reduce the capacitor voltage (V_{C}) when the weight current (I_{W}) flows by the spike input circuit 64, and can make the capacitor voltage (V_{C}) constant when the weight current (I_{W}) does not flow by the spike input circuit 64. Accordingly, the charge adjustment circuit 72 can reduce the capacitor voltage (V_{C}) when the spike input circuit 64 is in the ON state, namely, when the spike signal (Sᵢₙ) is the first voltage. In addition, the charge adjustment circuit 72 can make the capacitor voltage (V_{C}) constant when the spike input circuit 64 is in the OFF state, namely, when the spike signal (Sᵢₙ) is the second voltage.

In the current supply circuit 74, when the weight current (I_{W}) flows by the spike input circuit 64, the resistance is determined by a predetermined constant voltage (Vₜₐᵤ), and a first current (Iₜₐᵤ) changes by the potential V_{C} of the second terminal 66b of the first capacitor 66. When the weight current (I_{W}) does not flow and the first capacitor 66 is in a discharged state, the first capacitor 66 is charged with the first current (Iₜₐᵤ). As a result, a delay occurs in the intensity change of a spike current Iₛ with respect to the spike signal (Sᵢₙ). For example, the current supply circuit 74 is a MOSFET. In the example of FIG. 6, the current supply circuit 74 is a P-channel MOSFET. The current supply circuit 74 that is a P-channel MOSFET has the gate to which the predetermined constant voltage (Vₜₐᵤ) is applied, the source connected to the power supply potential, and the drain connected to the drain of the charge adjustment circuit 72. Then, in such a current supply circuit 74, when the weight current (I_{W}) flows by the spike input circuit 64, the first current (Iₜₐᵤ) changes by the potential V_{C} of the second terminal 66b of the first capacitor 66. In addition, when the weight current (I_{W}) does not flow and the first capacitor 66 is in a discharged state, the first capacitor 66 is charged with the first current (Iₜₐᵤ). As a result, a delay occurs in the intensity change of the spike current I_{S}.

When the weight current (I_{W}) flows by the spike input circuit 64, the current control circuit 76 supplies a control current (I_{cont}) corresponding to the control voltage (V_{cont}) to the node A. For example, the current control circuit 76 is a MOSFET. In the example of FIG. 6, the current control circuit 76 is an N-channel MOSFET. The current control circuit 76 that is an N-channel MOSFET has the gate to which the control voltage (V_{cont}) is applied, the drain connected to the power supply potential, and the source connected to the node A. Then, when the weight current (I_{W}) flows by the spike input circuit 64, such a current control circuit 76 supplies the control current (I_{cont}) to the node A via the charge adjustment circuit 72.

In such a propagation circuit 60, the capacitor voltage (V_{C}) starts decreasing from a first time when the spike signal (Sᵢₙ) changes from the second voltage to the first voltage. Then, the synaptic current (I_{S}) causes a current of a current amount corresponding to the capacitor voltage (V_{C}) to flow.

Here, the temporal change amount of the capacitor voltage (V_{C}) changes with the magnitudes of the weight current (I_{W}) and the control current (I_{cont}). The weight current (I_{W}) is a current amount corresponding to the synaptic weight (W) held by the synaptic weight holding circuit 56. The control current (I_{cont}) is a current amount corresponding to the control signal supplied from the first neuron circuit 32. Accordingly, the first synapse circuit 30 having such a configuration can output the synaptic current (Iₛ) of a current amount corresponding to the synaptic weight (W) and the control signal.

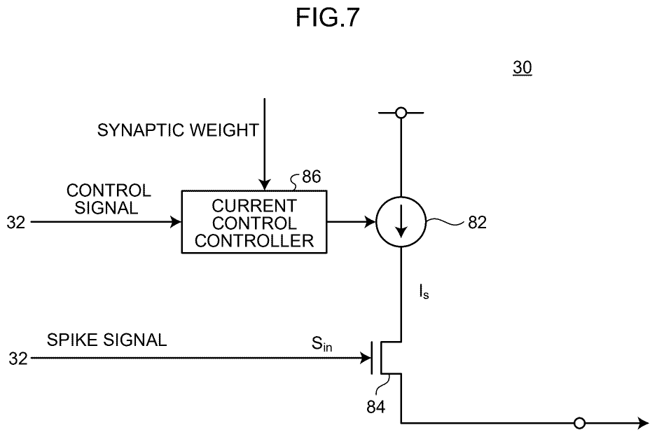

FIG. 7 is a diagram illustrating a second example of a configuration of the first synapse circuit 30. For example, in a case where the control signal is digital data, the first synapse circuit 30 may have a configuration as illustrated in FIG. 7. In a case where the control signal is digital data, for example, the first synapse circuit 30 includes a synaptic current source 82, a synapse output circuit 84, and a current control controller 86.

The synaptic current source 82 is a variable current source. The synaptic current source 82 outputs a synaptic current (Iₛ) of a current amount corresponding to the control by the current control controller 86.

The synapse output circuit 84 receives the spike signal (Sᵢₙ) output from the first neuron circuit 32. The synapse output circuit 84 switches whether or not to output the synaptic current (Iₛ) output from the synaptic current source 82 to the outside in accordance with the spike signal (Sᵢₙ) output from the first neuron circuit 32. For example, the synapse output circuit 84 outputs the synaptic current (Iₛ) to the outside in a case where the spike signal (Sᵢₙ) is the first voltage, and does not output the synaptic current (Iₛ) to the outside in a case where the spike signal (Sᵢₙ) is the second voltage.

For example, the synapse output circuit 84 is a MOSFET. In the example of FIG. 7, the output amplifier circuit 68 is an N-channel MOSFET. The synapse output circuit 84 that is an N-channel MOSFET has the gate to which the spike signal (Sᵢₙ) is applied, the drain connected to the synaptic current source 82, and the source connected to the output terminal. Then, the synapse output circuit 84 that is a MOSFET switches whether to flow the synaptic current (Iₛ) between the drain and the source in accordance with the spike signal (Sᵢₙ).

The current control controller 86 includes, for example, a digital circuit. The current control controller 86 acquires a control signal that is digital data from the first neuron circuit 32. In addition, in the current control controller 86, a synaptic weight is set from the outside. Then, the current control controller 86 controls the current amount of the synaptic current (Iₛ) to be output from the synaptic current source 82 in accordance with the synaptic weight and the control signal.

The first synapse circuit 30 having such a configuration can output the synaptic current (Iₛ) of a current amount corresponding to the synaptic weight (W) and the control signal.

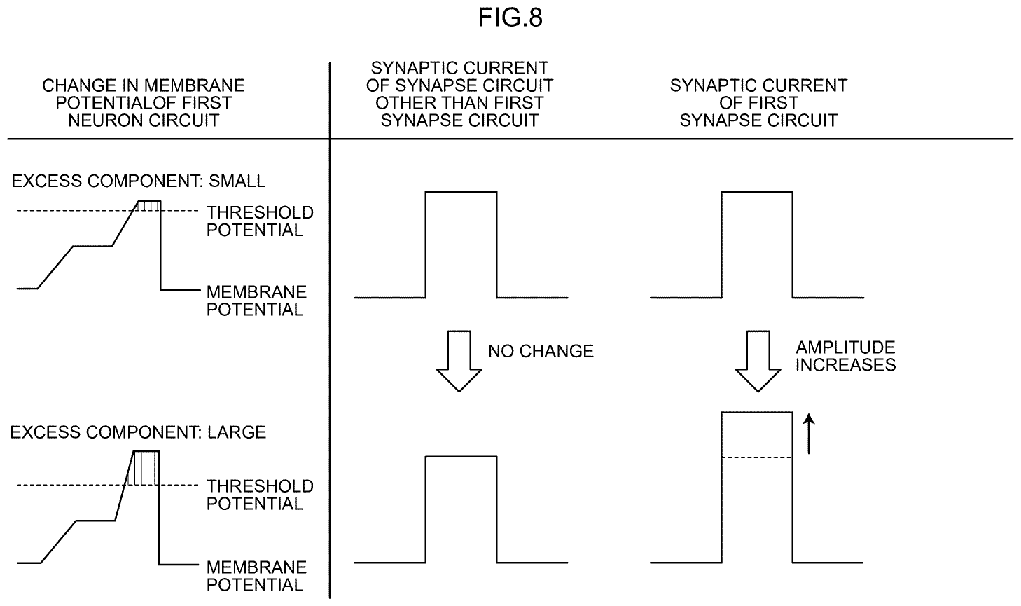

FIG. 8 is a diagram illustrating an example of waveforms of the membrane potential Vₘₑₘ and the synaptic current according to the first embodiment.

The synapse circuits 20 other than the first synapse circuits 30 do not receive the control signal. Accordingly, the synapse circuits 20 other than the first synapse circuits 30 do not change the amplitude of the synaptic current regardless of the magnitude of the excess component of the membrane potential Vₘₑₘ exceeding the threshold potential Vₜₕ.

On the other hand, the first neuron circuit 32 according to the first embodiment applies the control signal indicating the comparison voltage based on the excess component at the time of firing of the spike signal to the first synapse circuit 30 of the subsequent stage. Then, the first synapse circuit 30 that has received the control signal changes the amplitude of the synaptic current in accordance with the magnitude of the control signal. For example, when the excess component of the membrane potential Vₘₑₘ exceeding the threshold potential Vₜₕ is large, the first synapse circuit 30 outputs a synaptic current having a larger amplitude than that when the excess component is small.

As described above, the neural network device 10 according to the first embodiment can reflect the excess component at the time of firing in the first neuron circuit 32 on the current amount of the synaptic current output from the first synapse circuit 30 of the subsequent stage of the first neuron circuit 32. As a result, with the neural network device 10 according to the first embodiment, it is possible to implement an accurate spiking-type neural network device with less missing of information to be transmitted and less information transmission delay.

### Second Embodiment

Next, a neural network device 10 according to a second embodiment will be described. Since the neural network device 10 according to the second embodiment has substantially the same function and configuration as those of the first embodiment, components having substantially the same function and configuration are denoted by the same reference numerals as those of the first embodiment, and detailed description thereof is omitted except for differences.

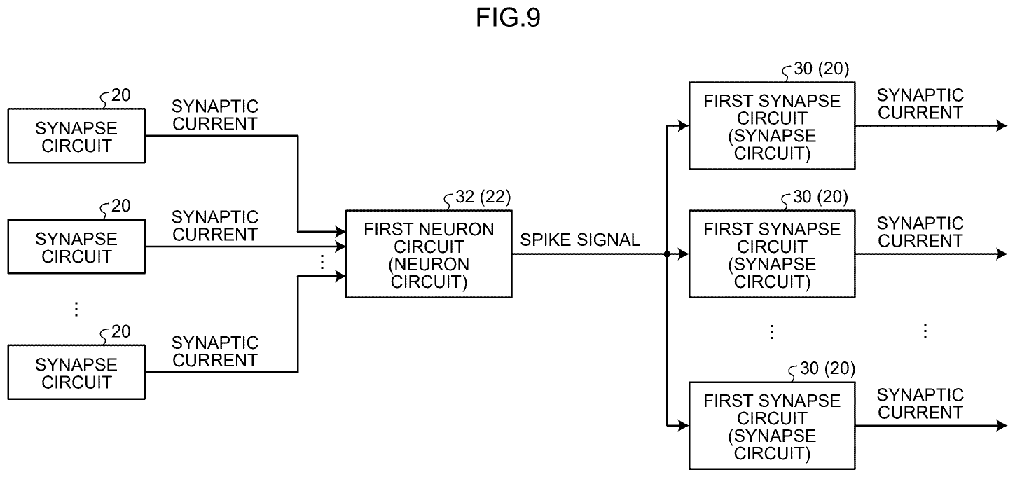

FIG. 9 is a diagram illustrating a connection relationship of a peripheral circuit of the first neuron circuit 32 according to the second embodiment.

The first neuron circuit 32 according to the second embodiment outputs a spike signal and does not output a control signal. However, the first neuron circuit 32 changes the time width of the voltage pulse of the spike signal in accordance with the control signal. For example, the first neuron circuit 32 increases the time width of the voltage pulse of the spike signal as the excess component of the membrane potential Vₘₑₘ exceeding the threshold potential Vₜₕ is larger.

When the spike signal is acquired from the first neuron circuit 32, each of the one or more first synapse circuits 30 outputs a synaptic current of the current amount corresponding to the time width of the voltage pulse of the acquired control signal and the synaptic weight. For example, each of the one or more first synapse circuits 30 increases the time width in which the synaptic current flows as the time width of the voltage pulse of the spike signal is larger. As a result, each of the one or more first synapse circuits 30 can increase the current amount of the synaptic current as the excess component at the time of firing of the first neuron circuit 32 is larger.

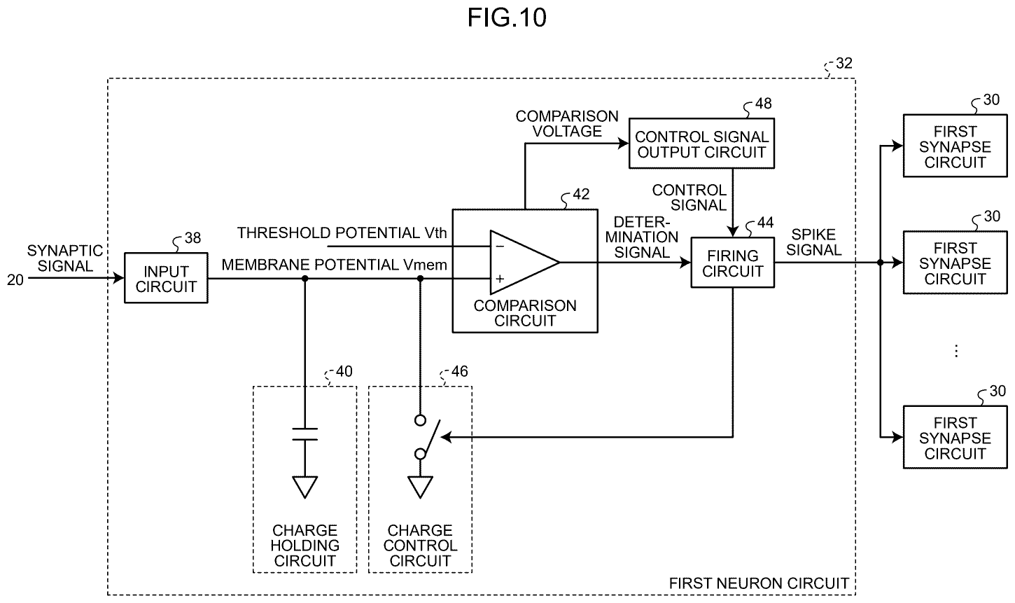

FIG. 10 is a diagram illustrating a configuration of the first neuron circuit 32 according to the second embodiment together with the first synapse circuits 30 connected to the first neuron circuit 32.

The control signal output circuit 48 according to the second embodiment applies the control signal to the firing circuit 44 instead of outputting the control signal to the first synapse circuit 30.

When the determination signal acquired from the comparison circuit 42 changes from the second value to the first value, the firing circuit 44 outputs a spike signal that is a voltage pulse with a time width corresponding to the control signal. For example, the firing circuit 44 increases the time width of the voltage pulse of the spike signal as the comparison voltage represented by the control signal is larger.

The first neuron circuit 32 having such a configuration can output a spike signal with a pulse width corresponding to the excess component of the membrane potential Vₘₑₘ exceeding the threshold potential Vₜₕ.

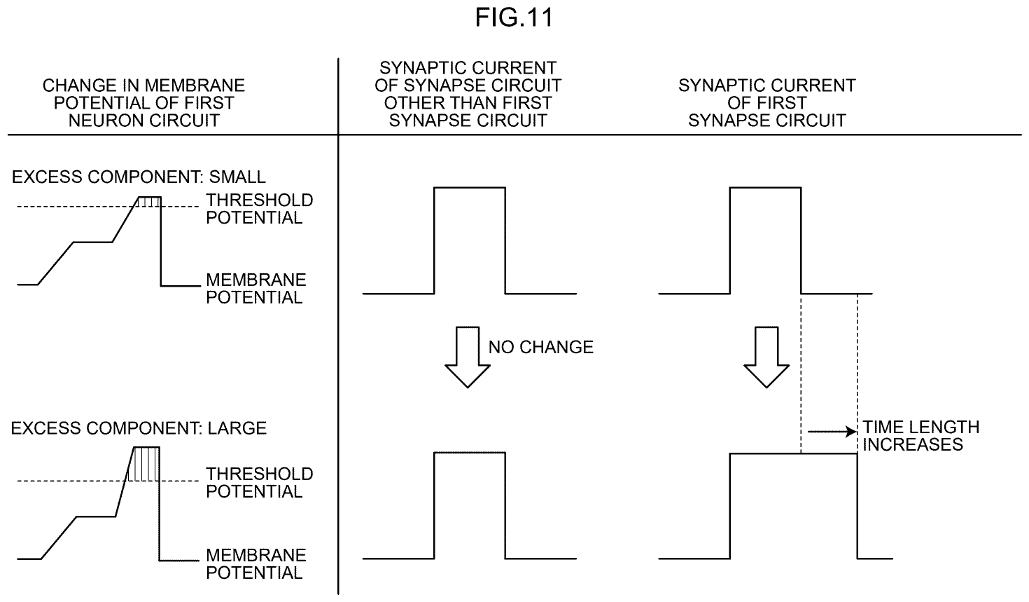

FIG. 11 is a diagram illustrating an example of waveforms of the membrane potential Vₘₑₘ and the synaptic current according to the second embodiment.

The synapse circuits 20 other than the first synapse circuits 30 receive the spike signal in which the time width of the voltage pulse is fixed. Accordingly, the synapse circuits 20 other than the first synapse circuits 30 do not change the time length for generating the synaptic current regardless of the magnitude of the excess component of the membrane potential Vₘₑₘ exceeding the threshold potential Vₜₕ.

On the other hand, the first neuron circuit 32 according to the second embodiment applies the spike signal of the voltage pulse with a time width, which differs with the excess component, to the first synapse circuit 30 of the subsequent stage. Then, the first synapse circuit 30 changes the time length for generating the synaptic current in accordance with the pulse width of the spike signal. For example, when the excess component of the membrane potential Vₘₑₘ exceeding the threshold potential Vₜₕ is large, the first synapse circuit 30 outputs a synaptic current having a predetermined amplitude for a longer time than when the excess component is small.

As described above, the neural network device 10 according to the second embodiment can reflect the excess component at the time of firing in the first neuron circuit 32 on the current amount of the synaptic current output from the first synapse circuit 30 of the subsequent stage of the first neuron circuit 32. As a result, with the neural network device 10 according to the second embodiment, it is possible to implement an accurate spiking-type neural network device with less missing of information to be transmitted and less information transmission delay.

### Third Embodiment

Next, a neural network device 10 according to a third embodiment will be described. Since the neural network device 10 according to the third embodiment has substantially the same function and configuration as those of the first embodiment, components having substantially the same function and configuration are denoted by the same reference numerals as those of the first embodiment, and detailed description thereof is omitted except for differences.

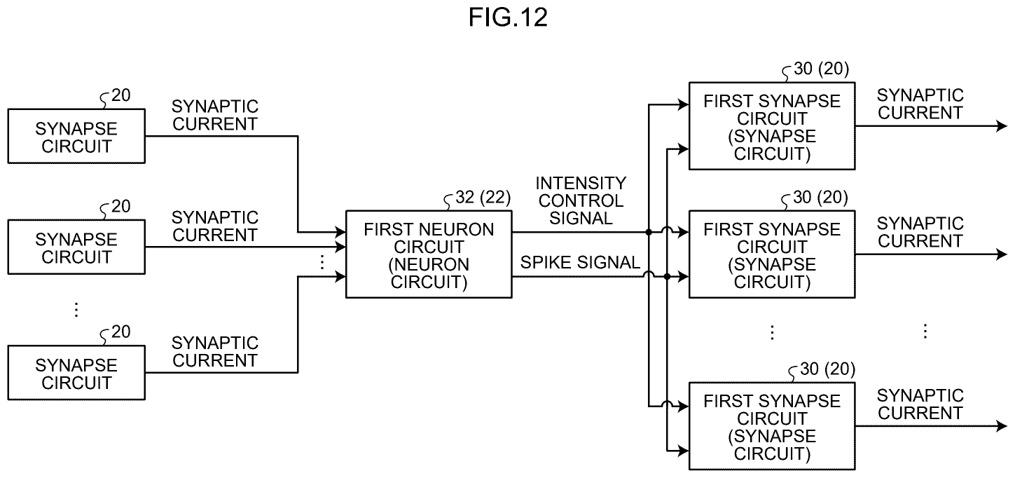

FIG. 12 is a diagram illustrating a connection relationship of a peripheral circuit of the first neuron circuit 32 according to the third embodiment.

The first neuron circuit 32 according to the third embodiment outputs an intensity control signal together with a spike signal. Similarly to the control signal according to the third embodiment, the intensity control signal represents the comparison voltage based on the excess component of the membrane potential Vₘₑₘ exceeding the threshold potential Vₜₕ. The intensity control signal may be an analog voltage or digital data.

The first neuron circuit 32 according to the third embodiment changes the time width of the voltage pulse of the spike signal in accordance with the control signal. For example, the first neuron circuit 32 increases the time width of the voltage pulse of the spike signal as the excess component of the membrane potential Vₘₑₘ exceeding the threshold potential Vₜₕ is larger.

In addition, each of one or more first synapse circuits 30, which acquires the spike signal from the first neuron circuit 32, acquires the intensity control signal instead of the control signal from the first neuron circuit 32.

When the spike signal is acquired from the first neuron circuit 32, each of the one or more first synapse circuits 30 outputs a synaptic current of the current amount corresponding to the time width of the voltage pulse of the acquired spike signal, the control signal, and the synaptic weight.

For example, in a case where the time width of the voltage pulse of the spike signal is the same, each of the one or more first synapse circuits 30 increases the amplitude of the output synaptic current as the comparison voltage represented by the control signal is larger. In addition, for example, in a case where the control signal is the same, each of the one or more first synapse circuits 30 increases the time length over which the synaptic current flows as the time width of the voltage pulse of the spike signal is larger. As a result, each of the one or more first synapse circuits 30 can increase the current amount of the output synaptic current as the excess component at the time of firing of the first neuron circuit 32 is larger.

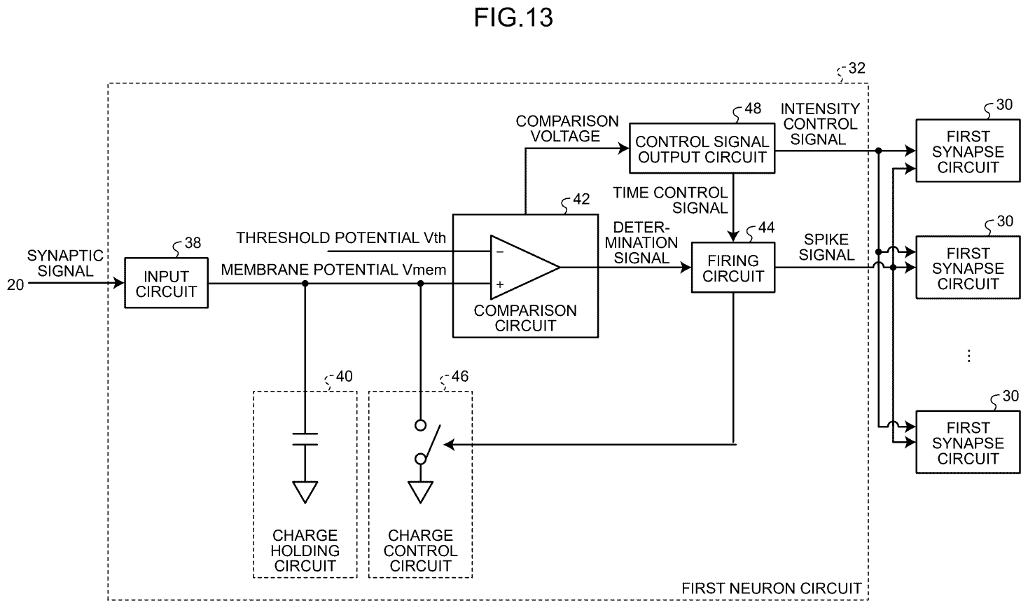

FIG. 13 is a diagram illustrating a configuration of the first neuron circuit 32 according to the third embodiment together with the first synapse circuits 30 connected to the first neuron circuit 32.

The control signal output circuit 48 according to the third embodiment outputs the intensity control signal and a time control signal as the control signals.

Each of the intensity control signal and the time control signal represents a comparison voltage. The intensity control signal and the time control signal may be signals of different forms. For example, one of the intensity control signal and the time control signal may be analog voltage and the other may be digital data. In addition, the intensity control signal and the time control signal may be signals having the same format and different values. Further, the intensity control signal and the time control signal may be signals of the same format and having the same value. At this time, the intensity control signal and the time control signal may be output from the same part of the control signal output circuit 48.

The control signal output circuit 48 applies the intensity control signal to each of the one or more first synapse circuits 30 connected to the first neuron circuit 32. In addition, the control signal output circuit 48 applies the time control signal to the firing circuit 44.

When the determination signal acquired from the comparison circuit 42 changes from the second value to the first value, the firing circuit 44 outputs a spike signal that is a voltage pulse with a time width corresponding to the time control signal. For example, the firing circuit 44 increases the time width of the voltage pulse of the spike signal as the comparison voltage represented by the time control signal is larger.

The first neuron circuit 32 having such a configuration can output a spike signal with a pulse width corresponding to the excess component of the membrane potential Vₘₑₘ exceeding the threshold potential Vₜₕ and can output the intensity control signal representing the excess component.

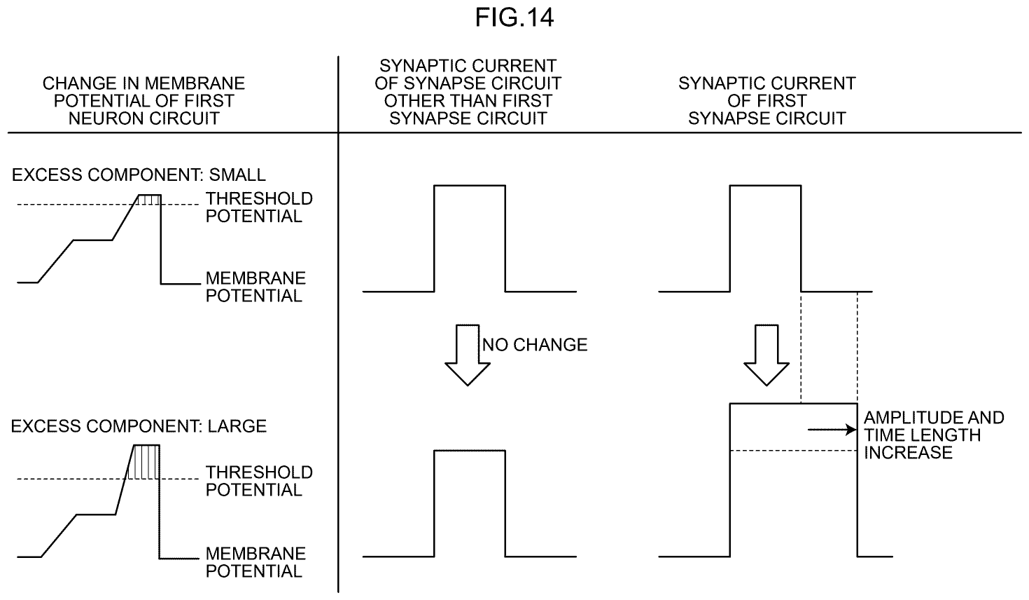

FIG. 14 is a diagram illustrating an example of waveforms of the membrane potential Vₘₑₘ and the synaptic current according to the third embodiment.

The synapse circuits 20 other than the first synapse circuits 30 do not receive the intensity control signal, but receive the spike signal in which the time width of the voltage pulse is fixed. Accordingly, the synapse circuits 20 other than the first synapse circuits 30 do not change the amplitude of the synaptic current or the time length for generating the synaptic current regardless of the magnitude of the excess component of the membrane potential Vₘₑₘ exceeding the threshold potential Vₜₕ.

On the other hand, the first neuron circuit 32 according to the third embodiment applies the intensity control signal corresponding to the excess component at the time of firing of the spike signal to the first synapse circuit 30 of the subsequent stage. Then, the first synapse circuit 30 that has received the intensity control signal changes the amplitude of the synaptic current in accordance with the magnitude of the intensity control signal. For example, when the excess component of the membrane potential Vₘₑₘ exceeding the threshold potential Vₜₕ is large, the first synapse circuit 30 outputs a synaptic current having a larger amplitude than that when the excess component is small.

Further, the first neuron circuit 32 according to the third embodiment applies, to the first synapse circuit 30 of the subsequent stage, the spike signal of the voltage pulse with a time width that varies with the excess component. Then, the first synapse circuit 30 changes the time length for generating the synaptic current in accordance with the pulse width of the spike signal. For example, when the excess component of the membrane potential Vₘₑₘ exceeding the threshold potential Vₜₕ is large, the first synapse circuit 30 outputs a synaptic current for a longer time than when the excess component is small.

As described above, the neural network device 10 according to the third embodiment can reflect the excess component at the time of firing in the first neuron circuit 32 on the current amount of the synaptic current output from the first synapse circuit 30 of the subsequent stage of the first neuron circuit 32. As a result, with the neural network device 10 according to the third embodiment, it is possible to implement an accurate spiking-type neural network device with less missing of information to be transmitted and less information transmission delay.

### Modifications of First Neuron Circuit 32

Next, modifications of the first neuron circuit 32 according to the first to third embodiments will be described. Note that, as the modifications described below, modifications of the first embodiment will be described, but similar modifications may be applied to the second embodiment and the third embodiment.

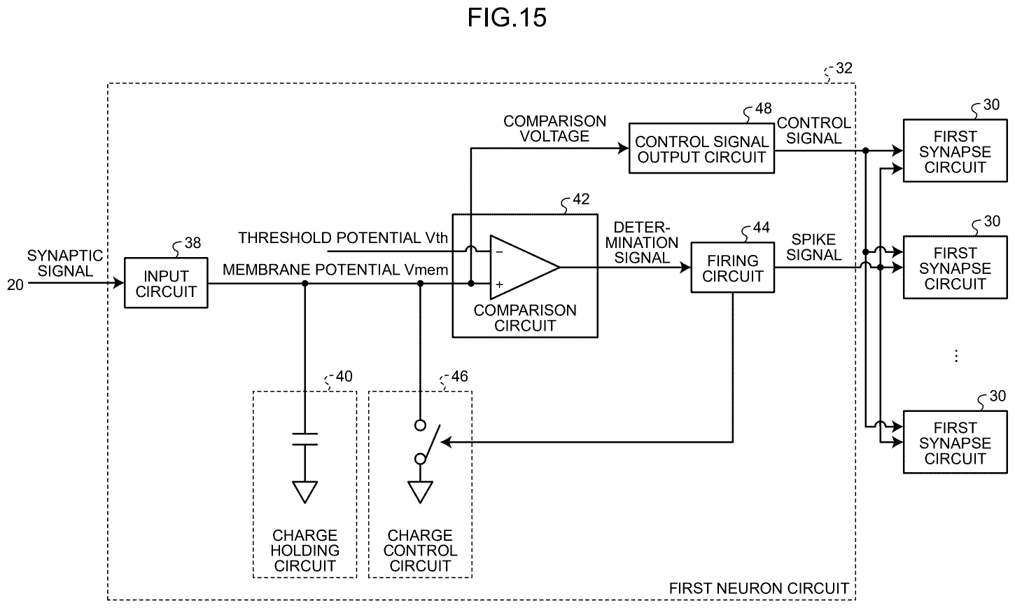

FIG. 15 is a diagram illustrating a configuration of the first neuron circuit 32 according to a first modification together with the first synapse circuits 30 connected to the first neuron circuit 32.

The control signal output circuit 48 according to the first modification acquires the membrane potential Vₘₑₘ as the comparison voltage. The threshold potential Vₜₕ is a fixed potential. For this reason, the membrane potential Vₘₑₘ is proportional to the excess component of the membrane potential Vₘₑₘ exceeding the threshold potential Vₜₕ. Accordingly, even when the membrane potential Vₘₑₘ is acquired as the comparison voltage, the control signal output circuit 48 can generate a control signal representing a proportional voltage based on the excess component of the membrane potential Vₘₑₘ exceeding the threshold potential Vₜₕ.

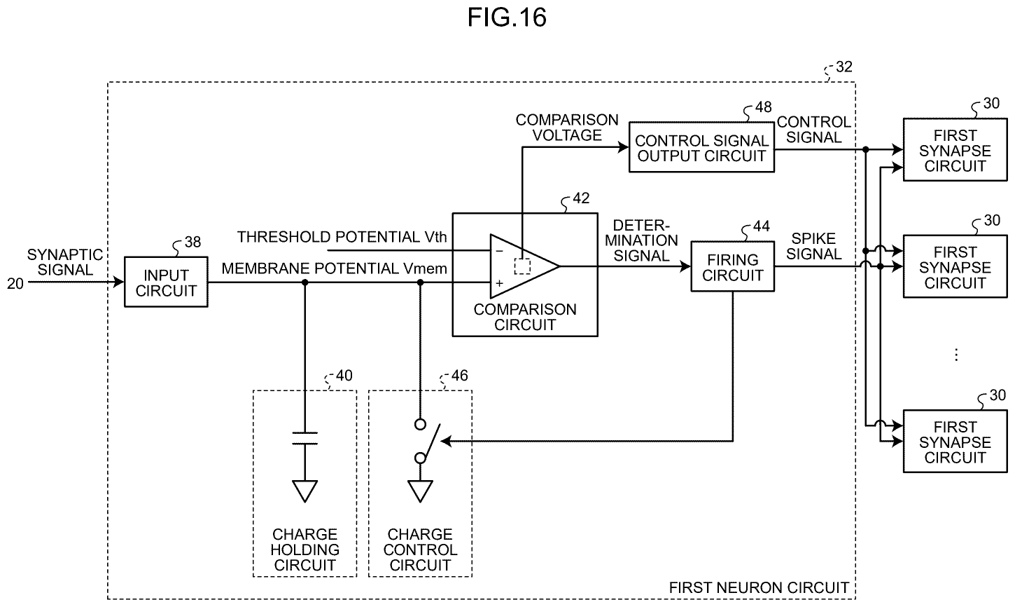

FIG. 16 is a diagram illustrating a configuration of the first neuron circuit 32 according to a second modification together with the first synapse circuits 30 connected to the first neuron circuit 32.

The control signal output circuit 48 according to the second modification acquires a difference voltage obtained by subtracting the threshold potential Vₜₕ from the membrane potential Vₘₑₘ from the comparison circuit 42 as the comparison voltage. The comparator included in the comparison circuit 42 internally generates a voltage representing a difference between the voltage of the non-inverting input terminal and the voltage of the inverting input terminal. The voltage representing the difference between the voltage of the non-inverting input terminal and the voltage of the inverting input terminal is a difference voltage obtained by subtracting the threshold potential Vₜₕ from the membrane potential Vₘₑₘ. Accordingly, the control signal output circuit 48 acquires the voltage representing the difference between the voltage of the non-inverting input terminal and the voltage of the inverting input terminal from the inside of the comparator included in the comparison circuit 42, thereby generating the control signal representing the proportional voltage based on the excess component of the membrane potential Vₘₑₘ exceeding the threshold potential Vₜₕ.

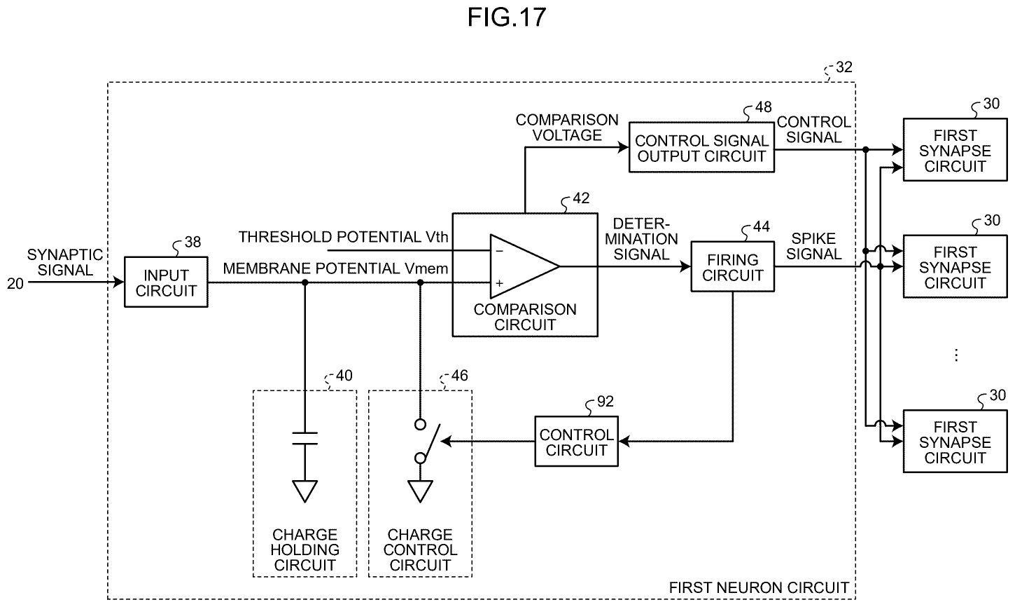

FIG. 17 is a diagram illustrating a configuration of the first neuron circuit 32 according to a third modification together with the first synapse circuits 30 connected to the first neuron circuit 32.

The first neuron circuit 32 according to the third modification further includes a control circuit 92. The control circuit 92 controls a timing at which the charge control circuit 46 charges or discharges the charge accumulated in the charge holding circuit 40. The control circuit 92 according to the present modification controls the release timing at which the charge accumulated in the charge holding circuit 40 is released in accordance with the timing at which the spike signal is output from the firing circuit 44.

For example, the control circuit 92 according to the present modification turns on the charge control circuit 46 to start release of the charges a predetermined time after the spike signal is output from the firing circuit 44, and turns off the charge control circuit 46 to stop release of the charges a predetermined time after the timing of starting the release of the charges. As a result, the first neuron circuit 32 according to the third modification can return the membrane potential Vₘₑₘ generated from the charge holding circuit 40 to the initial potential after the spike signal is output from the firing circuit 44.

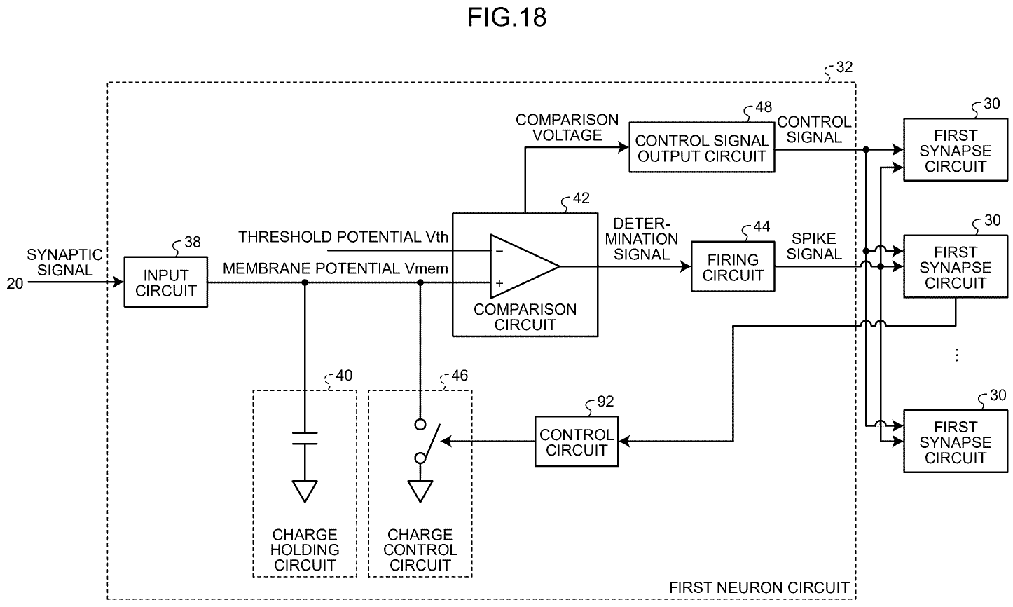

FIG. 18 is a diagram illustrating a configuration of the first neuron circuit 32 according to a fourth modification together with the first synapse circuits 30 connected to the first neuron circuit 32.

The first neuron circuit 32 according to the fourth modification also further includes a control circuit 92 similarly to the third modification. The control circuit 92 according to the present modification controls the timing at which the charges accumulated in the charge holding circuit 40 are charged and discharged in accordance with the timing at which one or more first synapse circuits 30 connected to the first neuron circuit 32 acquire the spike signal.

For example, the control circuit 92 according to the present modification receives a feedback signal indicating the spike signal acquisition timing from any one first synapse circuit 30 of the one or more first synapse circuits 30. Then, for example, the control circuit 92 according to the present modification turns on the charge control circuit 46 to start release of the charges a predetermined time after the feedback signal is received, and turns off the charge control circuit 46 to stop release of the charges a predetermined time after the timing of starting the release of the charges. As a result, the first neuron circuit 32 according to the fourth modification can return the membrane potential Vₘₑₘ generated from the charge holding circuit 40 to the initial potential after the one or more first synapse circuits 30 acquire the spike signal.

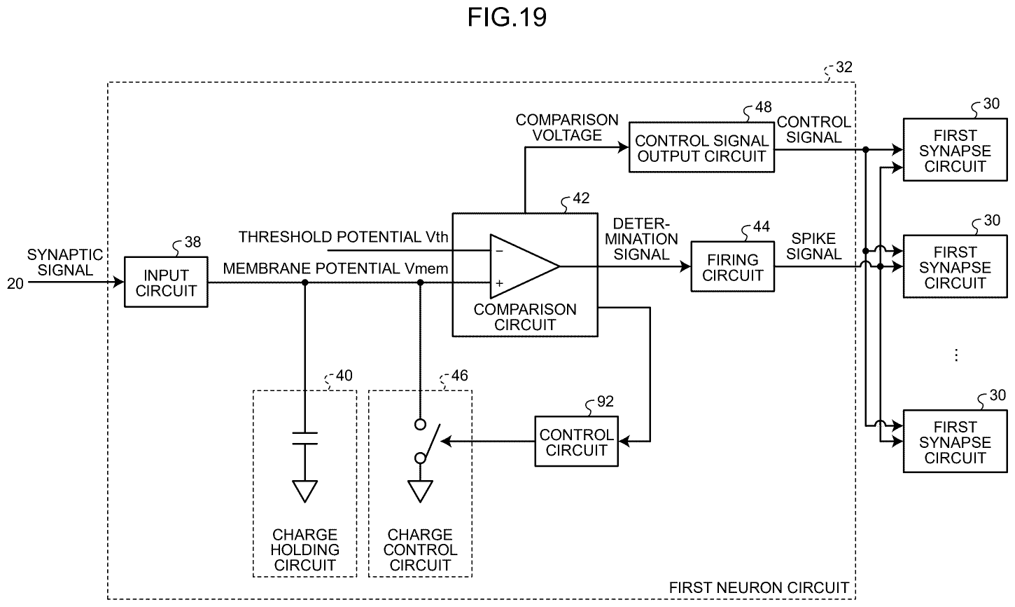

FIG. 19 is a diagram illustrating a configuration of the first neuron circuit 32 according to a fifth modification together with the first synapse circuits 30 connected to the first neuron circuit 32.

The first neuron circuit 32 according to the fifth modification also further includes a control circuit 92 similarly to the third modification. The control circuit 92 according to the present modification controls the timing at which the charges accumulated in the charge holding circuit 40 are charged and discharged in accordance with the timing at which the determination signal output from the comparison circuit 42 is changed from the second value to the first value. For example, the control circuit 92 according to the present modification controls the release timing at which the charges accumulated in the charge holding circuit 40 are released in accordance with the timing when the state in which the comparison circuit 42 determines that the membrane potential Vₘₑₘ is not larger than the threshold potential Vₜₕ is changed to the state in which the comparison circuit 42 determines that the membrane potential Vₘₑₘ is larger than the threshold potential Vₜₕ.

For example, the control circuit 92 according to the present modification receives the determination signal from the comparison circuit 42. Then, for example, the control circuit 92 according to the present modification turns on the charge control circuit 46 to start release of the charges a predetermined time after the determination signal is changed from the second value to the first value, and turns off the charge control circuit 46 to stop release of the charges a predetermined time after the timing of starting the release of the charges. As a result, the first neuron circuit 32 according to the fifth modification can return the membrane potential Vₘₑₘ generated from the charge holding circuit 40 to the initial potential after the comparison circuit 42 determines that the membrane potential Vₘₑₘ is larger than the threshold potential Vₜₕ.

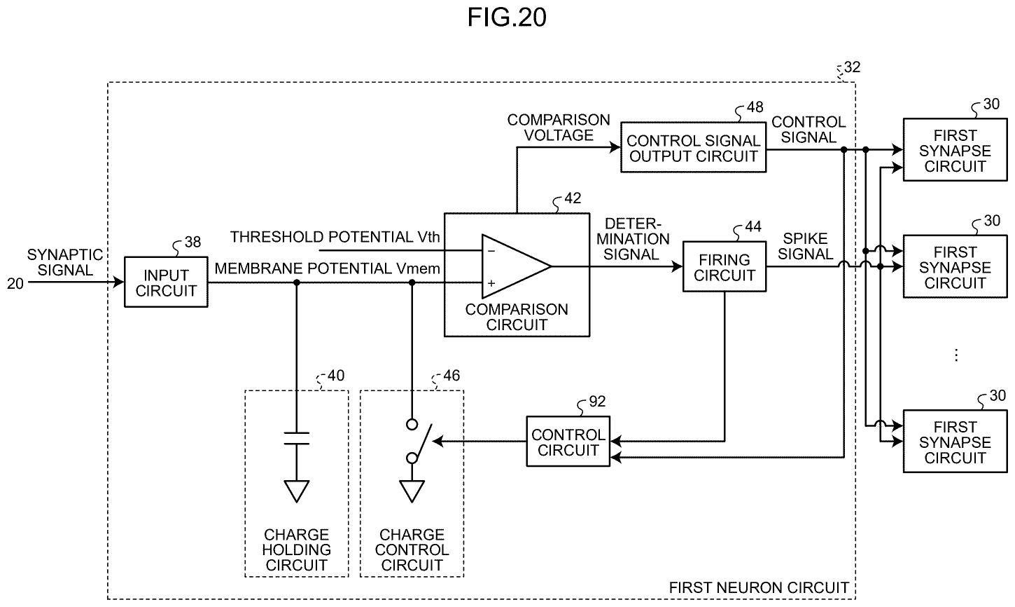

FIG. 20 is a diagram illustrating a configuration of the first neuron circuit 32 according to a sixth modification together with the first synapse circuits 30 connected to the first neuron circuit 32.

The first neuron circuit 32 according to the sixth modification also further includes a control circuit 92 similarly to the third modification. Further, the control circuit 92 according to the present modification acquires a control signal from the control signal output circuit 48. Then, the control circuit 92 according to the present modification changes the time during which the charge control circuit 46 charges or discharges the charges accumulated in the charge holding circuit 40 in accordance with the control signal. For example, the control circuit 92 according to the present modification increases the release time as the excess component of the membrane potential Vₘₑₘ exceeding the threshold potential Vₜₕ is larger. For example, the control circuit 92 according to the present modification increases the release time as the membrane potential Vₘₑₘ is larger or as the difference obtained by subtracting the threshold potential Vₜₕ from the membrane potential Vₘₑₘ is larger.

For example, the control circuit 92 according to the present modification turns on the charge control circuit 46 to start release of the charges after a predetermined time after the spike signal is output from the firing circuit 44. Then, the control circuit 92 according to the present modification turns off the charge control circuit 46 to stop release of the charges after an elapsed time corresponding to the control signal from the timing at which the release of the charges is started. As a result, the first neuron circuit 32 according to the sixth modification can adjust the time for discharging the charges using the charge control circuit 46 in accordance with the amount of charges accumulated in the charge holding circuit 40. Accordingly, the first neuron circuit 32 according to the sixth modification can start charge accumulation in a shorter time after the membrane potential Vₘₑₘ generated from the charge holding circuit 40 is returned to the initial potential.

Note that, similarly to the sixth modification, the control circuit 92 according to the fourth and fifth modifications may change the release time during which the charge control circuit 46 releases the charges accumulated in the charge holding circuit 40 in accordance with the control signal.

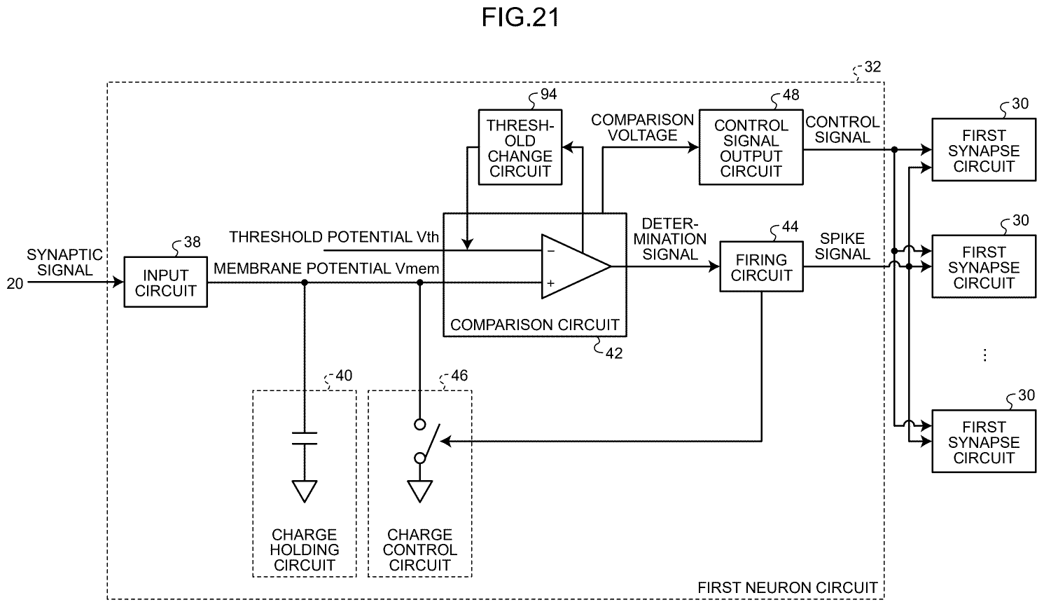

FIG. 21 is a diagram illustrating a configuration of the first neuron circuit 32 according to a seventh modification together with the first synapse circuits 30 connected to the first neuron circuit 32.

The first neuron circuit 32 according to the seventh modification further includes a threshold change circuit 94. The threshold change circuit 94 changes the threshold potential Vₜₕ in accordance with the comparison voltage.

For example, the threshold change circuit 94 acquires, as the comparison voltage, a difference voltage obtained by subtracting the threshold potential Vₜₕ from the membrane potential Vₘₑₘ. Then, the threshold change circuit 94 may lower the threshold potential Vₜₕ when the difference voltage obtained by subtracting the threshold potential Vₜₕ from the membrane potential Vₘₑₘ is larger than zero, namely, when the membrane potential Vₘₑₘ is larger than the threshold potential Vₜₕ, and may return the threshold potential Vₜₕ to a preset potential when the membrane potential Vₘₑₘ is smaller than the threshold potential Vₜₕ. In addition, the threshold change circuit 94 may apply, to the threshold potential Vₜₕ, a voltage obtained by amplifying the difference voltage obtained by subtracting the threshold potential Vₜₕ from the membrane potential Vₘₑₘ.

The first neuron circuit 32 according to the seventh modification can prevent a chattering state in which the value of the determination signal is alternately switched in a short period of time when the difference between the membrane potential Vₘₑₘ and the threshold potential Vₜₕ is small. Note that the threshold change circuit 94 may acquire the control signal from the control signal output circuit 48 and change the threshold potential Vₜₕ based on the control signal.

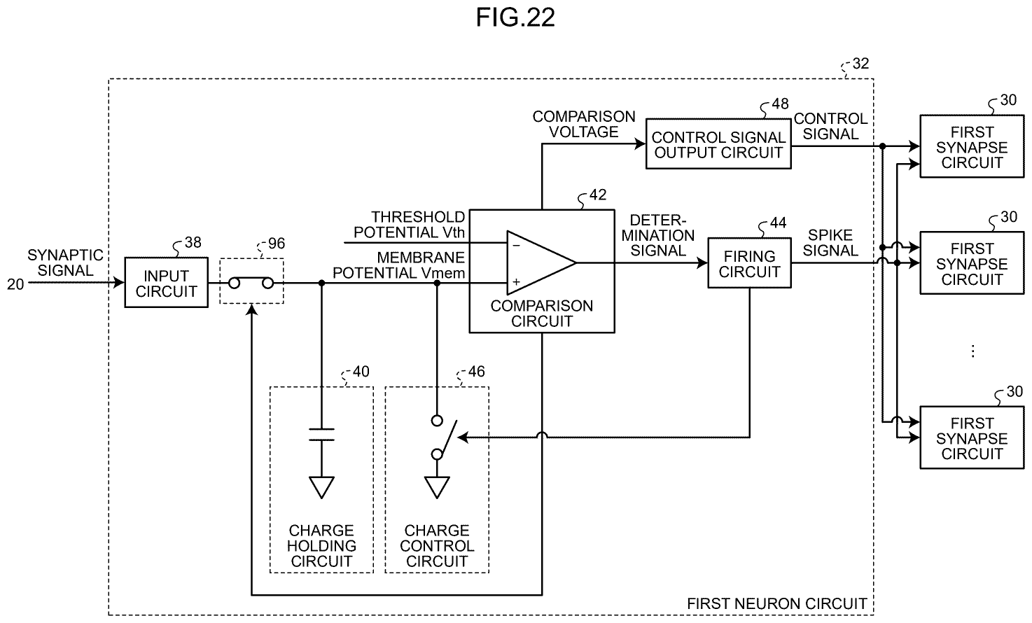

FIG. 22 is a diagram illustrating a configuration of the first neuron circuit 32 according to an eighth modification together with the first synapse circuits 30 connected to the first neuron circuit 32.

The first neuron circuit 32 according to the eighth modification further includes a shut-off switch 96. The shut-off switch 96 switches between an ON state in which the synaptic current is supplied from the input circuit 38 to the charge holding circuit 40 and an OFF state in which the supply of the synaptic current from the input circuit 38 to the charge holding circuit 40 is shut off. The shut-off switch 96 is implemented by, for example, a MOSFET. In addition, the shut-off switch 96 may be implemented by a current mirror circuit, a potentiometer, a variable resistance memory element, a phase change memory element, a variable magnetic resistance memory, a flip-flop circuit, or the like.

In the eighth modification, the shut-off switch 96 acquires the determination signal from the comparison circuit 42. The shut-off switch 96 switches from the ON state to the OFF state in response to a change in the determination signal from the second value to the first value. Then, the shut-off switch 96 switches from the OFF state to the ON state after a predetermined time has elapsed from the timing of switching from the ON state to the OFF state.

As a result, the first neuron circuit 32 according to the eighth modification can stop the further supply of the synaptic current to the charge holding circuit 40 after the membrane potential Vₘₑₘ exceeds the threshold potential Vₜₕ. In addition, the first neuron circuit 32 according to the eighth modification can set a refractory period during which the first neuron circuit 32 does not respond after firing the spike signal.

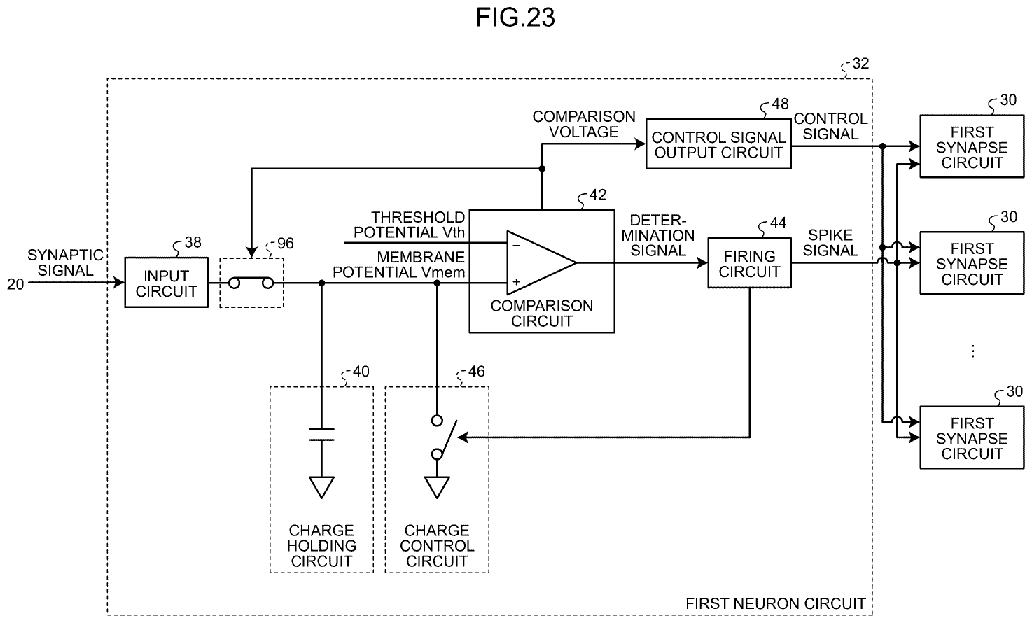

FIG. 23 is a diagram illustrating a configuration of the first neuron circuit 32 according to a ninth modification together with the first synapse circuits 30 connected to the first neuron circuit 32.

The first neuron circuit 32 according to the ninth modification also further includes a shut-off switch 96 similarly to the eighth modification. In the ninth modification, the shut-off switch 96 acquires the comparison voltage or the control signal. The shut-off switch 96 switches from the ON state to the OFF state in response to a comparison signal exceeding a predetermined voltage. Then, the shut-off switch 96 switches from the OFF state to the ON state after a predetermined time has elapsed from the timing of switching from the ON state to the OFF state.

As a result, the first neuron circuit 32 according to the ninth modification can stop the further supply of the synaptic current to the charge holding circuit 40 after the membrane potential Vₘₑₘ exceeds the threshold potential Vₜₕ and can prevent the excess component of the membrane potential Vₘₑₘ exceeding the threshold potential Vₜₕ from being increased. In addition, the first neuron circuit 32 according to the ninth modification can set a refractory period during which the first neuron circuit 32 does not respond after firing the spike signal.

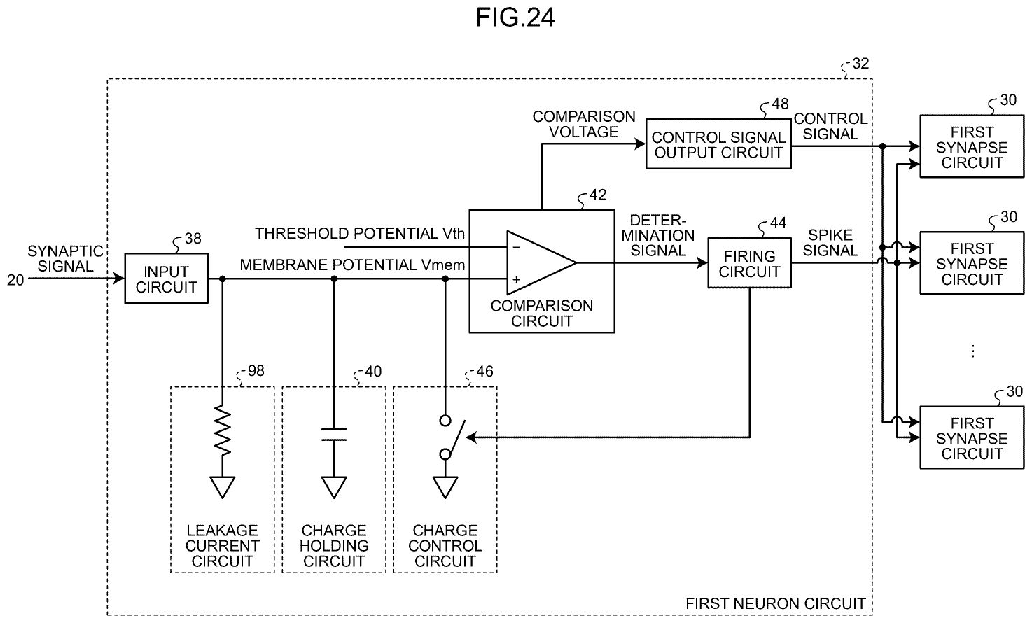

FIG. 24 is a diagram illustrating a configuration of the first neuron circuit 32 according to a tenth modification together with the first synapse circuits 30 connected to the first neuron circuit 32.

The first neuron circuit 32 according to the tenth modification further includes a leakage current circuit 98. The leakage current circuit 98 reduces the charges accumulated in the charge holding circuit 40 with the lapse of time. The leakage current circuit 98 is connected in parallel between the two terminals of the charge holding circuit 40, and causes a leakage current to flow from the generation terminal of the membrane potential Vₘₑₘ of the charge holding circuit 40 to the ground terminal to leak the charges accumulated in the charge holding circuit 40. Accordingly, when the synaptic current is not supplied, the charge holding circuit 40 lowers the membrane potential Vₘₑₘ with the lapse of time.

For example, the leakage current circuit 98 is a resistance element mounted on a semiconductor device. The resistance element is connected between a first terminal 34 and the ground terminal. The magnitude of the leak current flowing from the leakage current circuit 98 is determined by the resistance value of the resistance element and the membrane potential Vₘₑₘ generated from the charge holding circuit 40. The resistance element has a relatively large resistance value of, for example, 100 MΩ or more, and releases the charges accumulated in the charge holding circuit 40 over a sufficiently long time. Alternatively, the resistance element may include a MOSFET. In this case, the leak current value is determined by the gate voltage of the MOSFET.

The first neuron circuit 32 according to the tenth modification can perform an operation that mimics a neuron according to the leak model. Note that the first neuron circuit 32 according to the tenth modification may further include the shut-off switch 96 described in the eighth modification or the ninth modification. In this case, the shut-off switch 96 may shut off the supply of the synaptic current to the leakage current circuit 98 in the OFF state. In addition, in the OFF state, the shut-off switch 96 shuts off the supply of the synaptic current to the charge holding circuit 40, but may continue the supply of the synaptic current to the leakage current circuit 98. In addition, the first neuron circuit 32 may include the shut-off switch 96 between the leakage current circuit 98 and the charge holding circuit 40, and may shut off the supply from the charge holding circuit 40 to the leakage current circuit 98 in the OFF state.

### Configuration Example of Hierarchy of Neural Network Device 10

Next, a hierarchical configuration example of the neural network device 10 will be described. The neural network device 10 may have a configuration illustrated in each hierarchical configuration example described below.

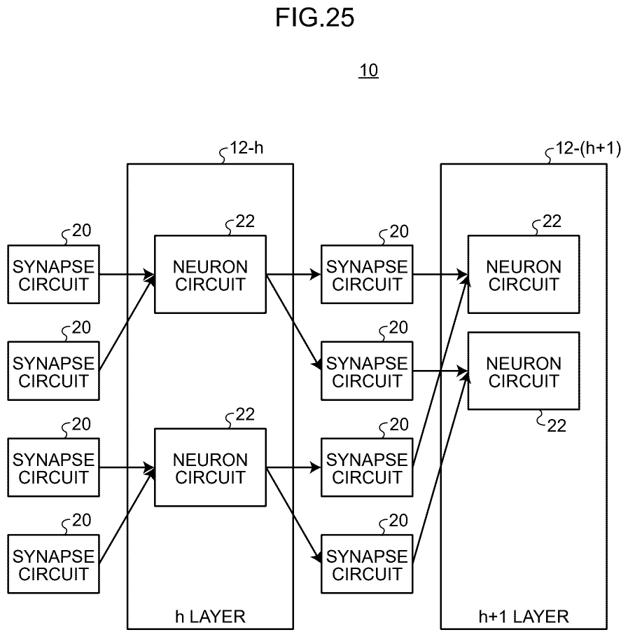

FIG. 25 is a diagram illustrating a neural network device 10 of a first hierarchical configuration example.

For example, the neural network device 10 includes forward coupling via the synapse circuits 20 between each of the neuron circuits 22 included in an optional h layer 12-h (h is an integer of 1 or more) and all the neuron circuits 22 included in a (h+1) layer 12-(h+1) next to the h layer 12-h. As described above, the neural network device 10 may include layers 12 that perform forward propagation by full coupling.

Note that, in the neural network device 10, all the neuron circuits 22 may have the same configuration as the first neuron circuit 32, or some of the neuron circuits 22 may have the same configuration as the first neuron circuit 32.

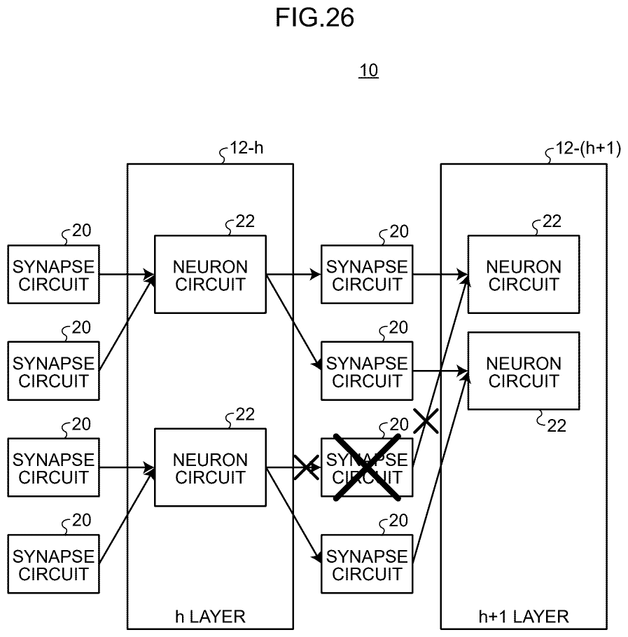

FIG. 26 is a diagram illustrating a neural network device 10 of a second hierarchical configuration example.

For example, in the neural network device 10, some of the neuron circuits 22 included in the h layer 12-h may not have a coupling relationship via the synapse circuits 20 with the neuron circuits 22 included in the (h+1) layer 12-(h+1).

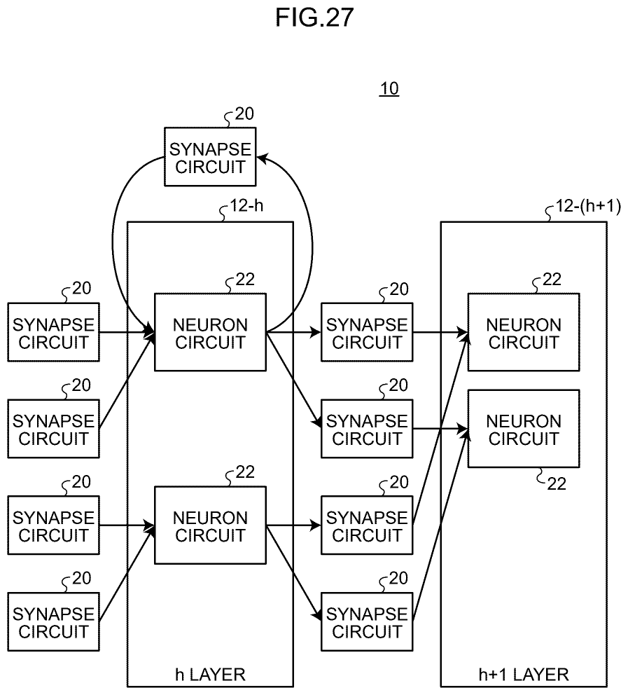

FIG. 27 is a diagram illustrating a neural network device 10 of a third hierarchical configuration example.

For example, in the neural network device 10, some of the neuron circuits 22 included in the h layer 12-h may be coupled to the synapse circuits 20 that back-propagate the synaptic current to their own inputs.

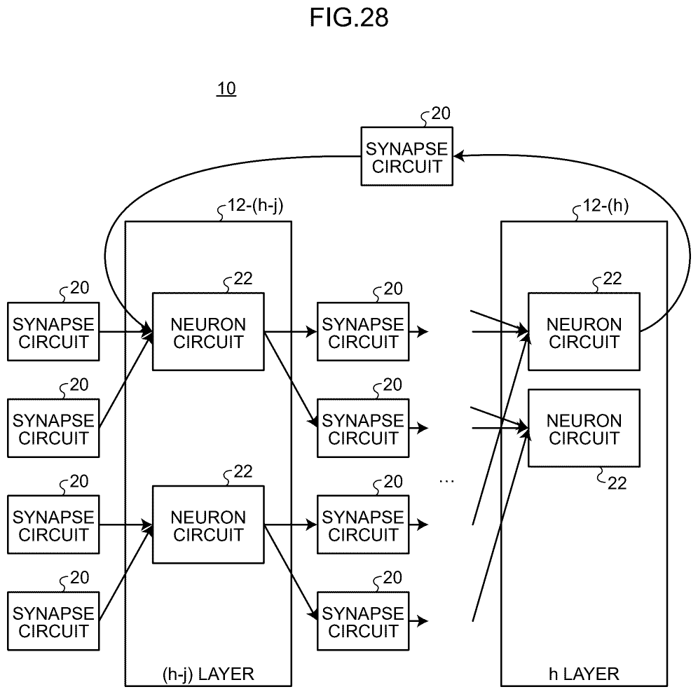

FIG. 28 is a diagram illustrating a neural network device 10 of a fourth hierarchical configuration example.

For example, in the neural network device 10, some of the neuron circuits 22 included in the h layer 12-h may be coupled to the neuron circuits 22 included in a (h−j) layer 12-(h−j) (j is an integer of 1 or more) as the preceding stage of the h layer 12-h via the synapse circuits 20.

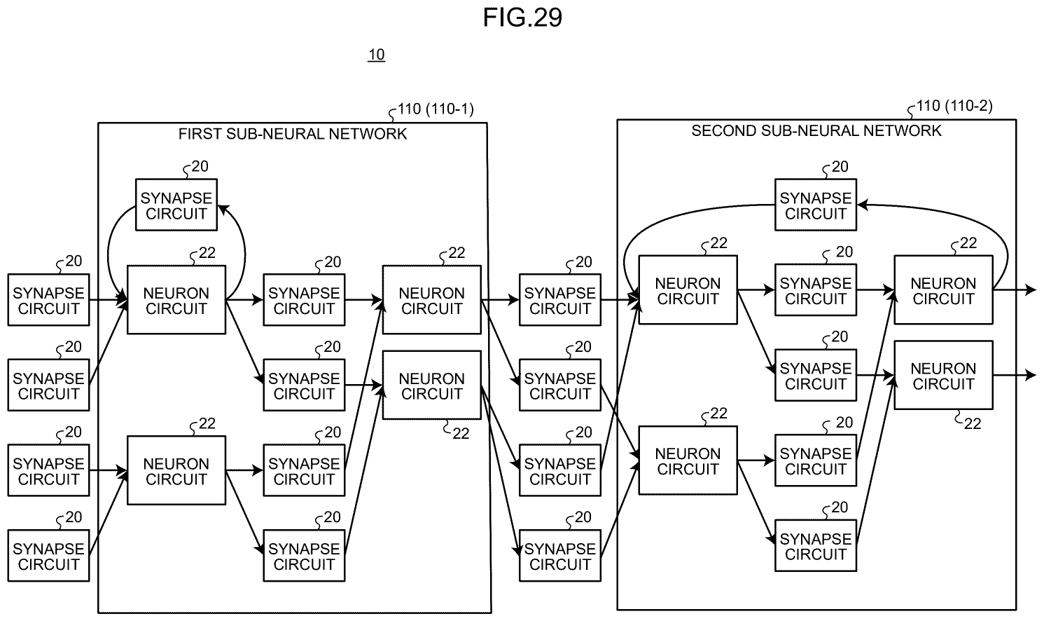

FIG. 29 is a diagram illustrating a neural network device 10 of a fifth hierarchical configuration example.

For example, the neural network device 10 may include a plurality of sub-neural networks 110 (110-1 and 110-2). In this case, the final stage of each of the sub-neural networks 110 (110-1 and 110-2) includes one or more neuron circuits 22. In addition, those other than the head sub-neural network 110-1 among the sub-neural networks 110 (110-1 and 110-2) are connected to another sub-neural network 110 via one or more synapse circuits 20.

In addition, each of the sub-neural networks 110 (110-1 and 110-2) may have any of the configurations of the first to fourth hierarchical configuration examples.

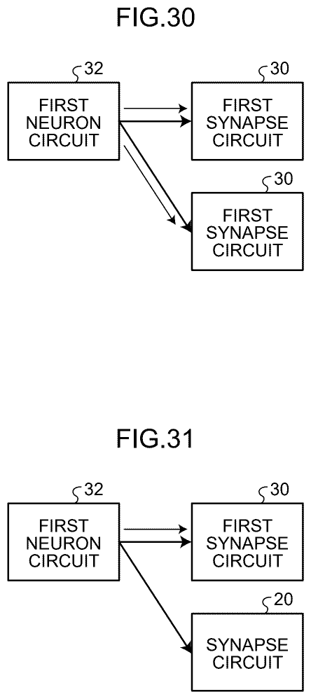

FIG. 30 is a diagram illustrating a connection relationship around a first neuron circuit 32 of a sixth hierarchical configuration example. For example, in the first neuron circuit 32 included in the neural network device 10, all the synapse circuits 20 connected as the subsequent stage may be the first synapse circuits 30.

FIG. 31 is a diagram illustrating a connection relationship around a first neuron circuit 32 of a seventh hierarchical configuration example. For example, in the first neuron circuit 32 included in the neural network device 10, some of the synapse circuits 20 connected as the subsequent stage may be the first synapse circuit 30, and some others may be the synapse circuit 20.

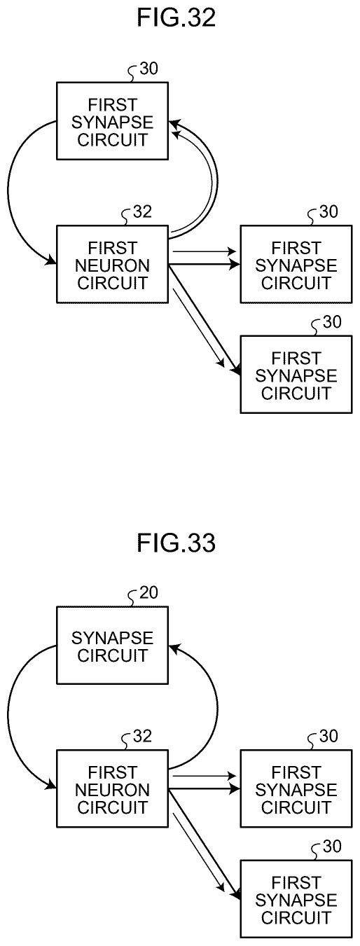

FIG. 32 is a diagram illustrating a connection relationship around a first neuron circuit 32 of an eighth hierarchical configuration example. For example, the first neuron circuit 32 included in the neural network device 10 may be coupled to a synapse circuit 20 that back-propagates the synaptic current to its own input. In this case, the synapse circuit 20 that back-propagates the synaptic current to its own input may be the first synapse circuit 30.

FIG. 33 is a diagram illustrating a connection relationship around a first neuron circuit 32 of a ninth hierarchical configuration example. In addition, for example, in a case where the first neuron circuit 32 included in the neural network device 10 is coupled to the synapse circuit 20 that back-propagates the synaptic current to its own input, the synapse circuit 20 that back-propagates the synaptic current to its own input may not be the first synapse circuit 30.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### Supplementary Notes

The above embodiment can be summarized in the following technical schemes.

### Technical Scheme 1

A neural network device comprising:
a plurality of synapse circuits, each of the synapse circuits being given a synaptic weight; and
a plurality of neuron circuits, each of the neuron circuits outputting a spike signal being a voltage pulse, wherein
each of the synapse circuits is configured to
   acquire the spike signal output from one of the neuron circuits, and,
   in response to acquiring the spike signal, output a synaptic current of a current amount corresponding to the synaptic weight given to the corresponding synapse circuit,
a first neuron circuit out of the neuron circuits includes
   an input circuit configured to acquire the synaptic current from one or more of the synapse circuits,
   a charge holding circuit configured to accumulate charge corresponding to the synaptic current acquired by the input circuit and generate a membrane potential corresponding to the accumulated charge,
   a comparison circuit configured to generate a determination signal with a first value or a second value, the first value being applied when a sign of a difference voltage between a preset threshold potential and the membrane potential is a first sign, the second value being applied when the sign of the difference voltage is a second sign different from the first sign,
   a firing circuit configured to output the spike signal when the determination signal changes from the second value to the first value,
   a charge control circuit configured to, after the spike signal is output, charge or discharge the charge accumulated in the charge holding circuit to cause the sign of the differential voltage to become the second sign, and
   a control signal output circuit configured to output a control signal representing a comparison voltage being based on an excess component of the membrane potential exceeding the threshold potential, and
each of one or more of first synapse circuits, by which the spike signal is acquired from the first neuron circuit, outputs the synaptic current with a current amount corresponding to the control signal and the synaptic weight in response to acquiring the spike signal from the first neuron circuit.

### Technical Scheme 2

A neural network device comprising:
a plurality of synapse circuits, each of the synapse circuits being given a synaptic weight; and
a plurality of neuron circuits, each of the neuron circuits outputting a spike signal being a voltage pulse, wherein
each of the synapse circuits is configured to
   acquire the spike signal output from one of the neuron circuits, and,
   in response to acquiring the spike signal, output a synaptic current of a current amount corresponding to the synaptic weight given to the corresponding synapse circuit,
a first neuron circuit out of the neuron circuits includes
   an input circuit configured to acquire the synaptic current from one or more of the synapse circuits,
   a charge holding circuit configured to accumulate charge corresponding to the synaptic current acquired by the input circuit and generate a membrane potential corresponding to the accumulated charge,
   a comparison circuit configured to generate a determination signal with a first value or a second value, the first value being applied when a sign of a difference voltage between a preset threshold potential and the membrane potential is a first sign, the second value being applied when the sign of the difference voltage is a second sign different from the first sign,
   a firing circuit configured to output the spike signal when the determination signal changes from the second value to the first value,
   a charge control circuit configured to, after the spike signal is output, charge or discharge the charge accumulated in the charge holding circuit to cause the sign of the differential voltage to become the second sign, and
   a control signal output circuit configured to output a control signal representing a comparison voltage being based on an excess component of the membrane potential exceeding the threshold potential,
the firing circuit outputs the spike signal having a voltage pulse with a time width corresponding to the control signal, and
each of one or more of first synapse circuits, by which the spike signal is acquired from the first neuron circuit, outputs the synaptic current with a current amount corresponding to the time width of the voltage pulse of the spike signal and the synaptic weight, in response to acquiring the spike signal from the first neuron circuit.

### Technical Scheme 3

The neural network device according to the technical scheme 2, wherein
the control signal output circuit outputs, as the control signal, an intensity control signal and a time control signal,
the firing circuit changes a time width for outputting the spike signal in accordance with the time control signal, and
each of the one or more first synapse circuits outputs, in response to acquiring the spike signal from the first neuron circuit, the synaptic current of a current amount corresponding to the time width of the spike signal, the intensity control signal, and the synaptic weight.

### Technical Scheme 4

The neural network device according to the technical scheme 2, wherein each of the one or more first synapse circuits outputs, in response to acquiring the spike signal from the first neuron circuit, the synaptic current of a current amount corresponding to the time width of the spike signal, the control signal, and the synaptic weight.

### Technical Scheme 5

The neural network device according to any one of the technical schemes 1 to 4, wherein the control signal output circuit acquires the membrane potential as the comparison voltage.

### Technical Scheme 6

The neural network device according to any one of the technical schemes 1 to 4, wherein the control signal output circuit acquires, as the comparison voltage from the comparison circuit, a difference voltage obtained by subtracting the threshold potential from the membrane potential.

### Technical Scheme 7

The neural network device according to any one of the technical schemes 1 to 6, wherein the first neuron circuit further includes a control circuit configured to control a timing at which the charge control circuit charges or discharges the charge accumulated in the charge holding circuit in accordance with a timing at which the spike signal is output from the firing circuit.

### Technical Scheme 8

The neural network device according to any one of the technical schemes 1 to 6, wherein the first neuron circuit further includes a control circuit configured to control a timing at which the charge control circuit charges or discharges the charge accumulated in the charge holding circuit in accordance with a timing at which the one or more first synapse circuits acquires the spike signal.

### Technical Scheme 9

The neural network device according to any one of the technical schemes 1 to 6, wherein the first neuron circuit further includes a control circuit configured to control a timing at which the charge control circuit charges or discharges the charge accumulated in the charge holding circuit in accordance with a timing at which the determination signal changes from the second value to the first value.

### Technical Scheme 10

The neural network device according to any one of the technical schemes 7 to 9, wherein the control circuit changes, in accordance with the control signal, a time during which the charge control circuit charges or discharges the charge accumulated in the charge holding circuit.

### Technical Scheme 11

The neural network device according to any one of the technical schemes 1 to 10, wherein the first neuron circuit further includes a threshold change circuit configured to change the threshold potential in accordance with the comparison voltage.

### Technical Scheme 12

The neural network device according to any one of the technical schemes 1 to 11, wherein
the first neuron circuit further includes a shut-off switch configured to switch between an ON state in which the synaptic current is supplied from the input circuit to the charge holding circuit and an OFF state in which supply of the synaptic current from the input circuit to the charge holding circuit is shut off, and
the shut-off switch switches from the ON state to the OFF state in response to a change in the determination signal from the second value to the first value.

### Technical Scheme 13

The neural network device according to any one of the technical schemes 1 to 11, wherein
the first neuron circuit further includes a shut-off switch configured to switch between an ON state in which the synaptic current is supplied from the input circuit to the charge holding circuit and an OFF state in which supply of the synaptic current from the input circuit to the charge holding circuit is shut off, and
the shut-off switch switches from the ON state to the OFF state in response to the comparison voltage becoming equal to or higher than a predetermined value.

### Technical Scheme 14

The neural network device according to any one of the technical schemes 1 to 13, wherein the first neuron circuit further includes a leakage current circuit configured to reduce the charge accumulated in the charge holding circuit with a lapse of time.

### Technical Scheme 15

A signal processing method implemented by a computer as a neural network device, the neural network device including a plurality of synapse circuits and a plurality of neuron circuits, each of the synapse circuits being given a synaptic weight, each of the neuron circuits outputting a spike signal being a voltage pulse, the signal processing method comprising:
acquiring, by each of the synapse circuits, the spike signal output from one of the neuron circuits;
outputting, by each of the synapse circuits in response to acquiring the spike signal, a synaptic current of a current amount corresponding to the synaptic weight given to the corresponding synapse circuit;
in a first neuron circuit out of the neuron circuits,
   acquiring, by an input circuit, the synaptic current from one or more of the synapse circuits;
   accumulating, by a charge holding circuit, charge corresponding to the synaptic current acquired by the input circuit and generate a membrane potential corresponding to the accumulated charge;
   generating, by a comparison circuit, a determination signal with a first value or a second value, the first value being applied when a sign of a difference voltage between a preset threshold potential and the membrane potential is a first sign, the second value being applied when the sign of the difference voltage is a second sign different from the first sign;
   outputting, by a firing circuit, the spike signal when the determination signal changes from the second value to the first value;
   charging or discharging, by a charge control circuit after the spike signal is output, the charge accumulated in the charge holding circuit to cause the sign of the differential voltage to become the second sign;
   outputting, by a control signal output circuit, a control signal representing a comparison voltage being based on an excess component of the membrane potential exceeding the threshold potential; and
   outputting, by each of one or more of first synapse circuits by which the spike signal is acquired from the first neuron circuit, the synaptic current with a current amount corresponding to the control signal and the synaptic weight in response to acquiring the spike signal from the first neuron circuit.

### Technical Scheme 16

A signal processing method implemented by a computer as a neural network device, the neural network device including a plurality of synapse circuits and a plurality of neuron circuits, each of the synapse circuits being given a synaptic weight, each of the neuron circuits outputting a spike signal being a voltage pulse, the signal processing method comprising:
acquiring, by each of the synapse circuits, the spike signal output from one of the neuron circuits;
outputting, by each of the synapse circuits in response to acquiring the spike signal, a synaptic current of a current amount corresponding to the synaptic weight given to the corresponding synapse circuit;
in a first neuron circuit out of the neuron circuits,
   acquiring, by an input circuit, the synaptic current from one or more of the synapse circuits;
   accumulating, by a charge holding circuit, charge corresponding to the synaptic current acquired by the input circuit and generate a membrane potential corresponding to the accumulated charge;
   generating, by a comparison circuit, a determination signal with a first value or a second value, the first value being applied when a sign of a difference voltage between a preset threshold potential and the membrane potential is a first sign, the second value being applied when the sign of the difference voltage is a second sign different from the first sign;
   outputting, by a firing circuit, the spike signal when the determination signal changes from the second value to the first value;
   charging or discharging, by a charge control circuit after the spike signal is output, the charge accumulated in the charge holding circuit to cause the sign of the differential voltage to become the second sign;
   outputting, by a control signal output circuit, a control signal representing a comparison voltage being based on an excess component of the membrane potential exceeding the threshold potential;
   outputting, by the firing circuit, the spike signal having a voltage pulse with a time width corresponding to the control signal; and
   outputting, by each of one or more of first synapse circuits by which the spike signal is acquired from the first neuron circuit, the synaptic current with a current amount corresponding to the time width of the voltage pulse of the spike signal and the synaptic weight in response to acquiring the spike signal from the first neuron circuit.

What is claimed is:

1. A neural network device comprising:
a plurality of synapse circuits, each of the synapse circuits being given a synaptic weight; and
a plurality of neuron circuits, each of the neuron circuits outputting a spike signal being a voltage pulse, wherein
each of the synapse circuits is configured to
acquire the spike signal output from one of the neuron circuits, and,
in response to acquiring the spike signal, output a synaptic current of a current amount corresponding to the synaptic weight given to the corresponding synapse circuit,
a first neuron circuit out of the neuron circuits includes
an input circuit configured to acquire the synaptic current from one or more of the synapse circuits,
a charge holding circuit configured to accumulate charge corresponding to the synaptic current acquired by the input circuit and generate a membrane potential corresponding to the accumulated charge,
a comparison circuit configured to generate a determination signal with a first value or a second value, the first value being applied when a sign of a difference voltage between a preset threshold potential and the membrane potential is a first sign, the second value being applied when the sign of the difference voltage is a second sign different from the first sign,
a firing circuit configured to output the spike signal when the determination signal changes from the second value to the first value,
a charge control circuit configured to, after the spike signal is output, charge or discharge the charge accumulated in the charge holding circuit to cause the sign of the differential voltage to become the second sign, and
a control signal output circuit configured to output a control signal representing a comparison voltage being based on an excess component of the membrane potential exceeding the threshold potential, and
each of one or more of first synapse circuits, by which the spike signal is acquired from the first neuron circuit, outputs the synaptic current with a current amount corresponding to the control signal and the synaptic weight in response to acquiring the spike signal from the first neuron circuit.

2. A neural network device comprising:
a plurality of synapse circuits, each of the synapse circuits being given a synaptic weight; and
a plurality of neuron circuits, each of the neuron circuits outputting a spike signal being a voltage pulse, wherein
each of the synapse circuits is configured to
acquire the spike signal output from one of the neuron circuits, and,
in response to acquiring the spike signal, output a synaptic current of a current amount corresponding to the synaptic weight given to the corresponding synapse circuit,
a first neuron circuit out of the neuron circuits includes
an input circuit configured to acquire the synaptic current from one or more of the synapse circuits,
a charge holding circuit configured to accumulate charge corresponding to the synaptic current acquired by the input circuit and generate a membrane potential corresponding to the accumulated charge,
a comparison circuit configured to generate a determination signal with a first value or a second value, the first value being applied when a sign of a difference voltage between a preset threshold potential and the membrane potential is a first sign, the second value being applied when the sign of the difference voltage is a second sign different from the first sign,
a firing circuit configured to output the spike signal when the determination signal changes from the second value to the first value,
a charge control circuit configured to, after the spike signal is output, charge or discharge the charge accumulated in the charge holding circuit to cause the sign of the differential voltage to become the second sign, and
a control signal output circuit configured to output a control signal representing a comparison voltage being based on an excess component of the membrane potential exceeding the threshold potential,
the firing circuit outputs the spike signal having a voltage pulse with a time width corresponding to the control signal, and
each of one or more of first synapse circuits, by which the spike signal is acquired from the first neuron circuit, outputs the synaptic current with a current amount corresponding to the time width of the voltage pulse of the spike signal and the synaptic weight, in response to acquiring the spike signal from the first neuron circuit.

3. The neural network device according to claim 2, wherein
the control signal output circuit outputs, as the control signal, an intensity control signal and a time control signal,
the firing circuit changes a time width for outputting the spike signal in accordance with the time control signal, and
each of the one or more first synapse circuits outputs, in response to acquiring the spike signal from the first neuron circuit, the synaptic current of a current amount corresponding to the time width of the spike signal, the intensity control signal, and the synaptic weight.

4. The neural network device according to claim 2, wherein each of the one or more first synapse circuits outputs, in response to acquiring the spike signal from the first neuron circuit, the synaptic current of a current amount corresponding to the time width of the spike signal, the control signal, and the synaptic weight.

5. The neural network device according to claim 1, wherein the control signal output circuit acquires the membrane potential as the comparison voltage.

6. The neural network device according to claim 1, wherein the control signal output circuit acquires, as the comparison voltage from the comparison circuit, a difference voltage obtained by subtracting the threshold potential from the membrane potential.

7. The neural network device according to claim 1, wherein the first neuron circuit further includes a control circuit configured to control a timing at which the charge control circuit charges or discharges the charge accumulated in the charge holding circuit in accordance with a timing at which the spike signal is output from the firing circuit.

8. The neural network device according to claim 1, wherein the first neuron circuit further includes a control circuit configured to control a timing at which the charge control circuit charges or discharges the charge accumulated in the charge holding circuit in accordance with a timing at which the one or more first synapse circuits acquires the spike signal.

9. The neural network device according to claim 1, wherein the first neuron circuit further includes a control circuit configured to control a timing at which the charge control circuit charges or discharges the charge accumulated in the charge holding circuit in accordance with a timing at which the determination signal changes from the second value to the first value.

10. The neural network device according to claim 7, wherein the control circuit changes, in accordance with the control signal, a time during which the charge control circuit charges or discharges the charge accumulated in the charge holding circuit.

11. The neural network device according to claim 1, wherein the first neuron circuit further includes a threshold change circuit configured to change the threshold potential in accordance with the comparison voltage.

12. The neural network device according to claim 1, wherein
the first neuron circuit further includes a shut-off switch configured to switch between an ON state in which the synaptic current is supplied from the input circuit to the charge holding circuit and an OFF state in which supply of the synaptic current from the input circuit to the charge holding circuit is shut off, and
the shut-off switch switches from the ON state to the OFF state in response to a change in the determination signal from the second value to the first value.

13. The neural network device according to claim 1, wherein
the first neuron circuit further includes a shut-off switch configured to switch between an ON state in which the synaptic current is supplied from the input circuit to the charge holding circuit and an OFF state in which supply of the synaptic current from the input circuit to the charge holding circuit is shut off, and
the shut-off switch switches from the ON state to the OFF state in response to the comparison voltage becoming equal to or higher than a predetermined value.

14. The neural network device according to claim 1, wherein the first neuron circuit further includes a leakage current circuit configured to reduce the charge accumulated in the charge holding circuit with a lapse of time.

15. A signal processing method implemented by a computer as a neural network device, the neural network device including a plurality of synapse circuits and a plurality of neuron circuits, each of the synapse circuits being given a synaptic weight, each of the neuron circuits outputting a spike signal being a voltage pulse, the signal processing method comprising:
acquiring, by each of the synapse circuits, the spike signal output from one of the neuron circuits;
outputting, by each of the synapse circuits in response to acquiring the spike signal, a synaptic current of a current amount corresponding to the synaptic weight given to the corresponding synapse circuit;
in a first neuron circuit out of the neuron circuits,
acquiring, by an input circuit, the synaptic current from one or more of the synapse circuits;
accumulating, by a charge holding circuit, charge corresponding to the synaptic current acquired by the input circuit and generate a membrane potential corresponding to the accumulated charge;
generating, by a comparison circuit, a determination signal with a first value or a second value, the first value being applied when a sign of a difference voltage between a preset threshold potential and the membrane potential is a first sign, the second value being applied when the sign of the difference voltage is a second sign different from the first sign;
outputting, by a firing circuit, the spike signal when the determination signal changes from the second value to the first value;
charging or discharging, by a charge control circuit after the spike signal is output, the charge accumulated in the charge holding circuit to cause the sign of the differential voltage to become the second sign;
outputting, by a control signal output circuit, a control signal representing a comparison voltage being based on an excess component of the membrane potential exceeding the threshold potential; and
outputting, by each of one or more of first synapse circuits by which the spike signal is acquired from the first neuron circuit, the synaptic current with a current amount corresponding to the excess component and the synaptic weight in response to acquiring the spike signal from the first neuron circuit.

16. The signal processing method according to claim 15, further comprising outputting, by each of the one or more of the first synapse circuits, the synaptic current with a current amount corresponding to the control signal and the synaptic weight in response to acquiring the spike signal from the first neuron circuit.

17. The signal processing method according to claim 15, further comprising:
outputting, by the firing circuit, the spike signal having a voltage pulse with a time width corresponding to the control signal; and
outputting, by each of one or more of first synapse circuits by which the spike signal is acquired from the first neuron circuit, the synaptic current with a current amount corresponding to the time width of the voltage pulse of the spike signal and the synaptic weight in response to acquiring the spike signal from the first neuron circuit.
